(19) United States
(12) Patent Application Publication
(10) Pub. No.: US 2014/0111454 A1
(43) Pub. Date: Apr. 24, 2014

(54) DISPLAY APPARATUS FOR VEHICLE AND INFORMATION DISPLAY DEVICE

(71) Applicant: DENSO CORPORATION, Kariya-city, Aichi-pref. (JP)

(72) Inventors: Toshihiro Hosoi, Nagoya-city (JP); Hironori Wada, Kariya-city (JP)

(73) Assignee: DENSO CORPORATION, Kariya-city, Aichi-pref. (JP)

(21) Appl. No.: 14/114,810

(22) PCT Filed: Apr. 23, 2012
(86) PCT No.: PCT/JP2012/061509

§ 371 Date: Jan. 10, 2014

(30) Foreign Application Priority Data
May 6, 2011 (JP) 2011-103729
Oct. 25, 2011 (JP) 2011-234391

(51) Int. Cl. B60R 1/00; G06F 3/041; H04M 1/02; G06F 3/0488

(52) U.S. Cl. CPC B60R 1/00; G06F 3/04883; G06F 3/041; H04M 1/0266
USPC 345/173

(57) ABSTRACT

A display apparatus communicating with a mobile terminal having a mobile touch panel includes: a vehicular touch panel displaying a vehicle-side image corresponding to a mobile image. The apparatus specifies a mobile position of the mobile touch panel corresponding to a touch position of the vehicular touch panel when a user touches the vehicular touch panel. The apparatus further includes: a detector detecting a slide operation of the touch position and a slid touch position of the vehicular touch panel; a conversion mode determination device determining a type and a direction of display coordinate conversion based on the slide operation, the touch position and the slid touch position; and a pseudo-operation information generation device generating pseudo-operation information indicating the mobile position and a slid mobile position corresponding to the slid touch position. The apparatus transmits the pseudo-operation information to the mobile terminal.

### CROSS REFERENCE TO RELATED APPLICATIONS

This application is based on Japanese Patent Applications No. 2011-103729 filed on May 6, 2011, and No. 2011-234391 filed on Oct. 25, 2011, the disclosures of which are incorporated herein by reference.

### TECHNICAL FIELD

The present disclosure relates to a display apparatus for a vehicle and an information display system.

### BACKGROUND ART

There are known mobile terminals such as touch-panel mobile telephones and tablet terminals that allow various operations based on gesture input on a touch panel. An example of the gesture input includes sliding a finger on the touch panel. The input operation parallel shifts a display on the screen. Generally, the shift quantity of a display corresponds to the operation quantity of a finger that slides on the touch panel.

Recently, there are known mobile terminals provided with a touch panel (hereinafter referred to as a multi-touch panel) capable of detecting multiple touch positions. The multi-touch panel can recognize the gesture input using user's multiple fingers. As disclosed in patent document 1, for example, the gesture input using multiple fingers can generate instructions to enlarge, reduce, or rotate displays on the screen. Generally, the quantity of enlarging or reducing a display corresponds to the operation quantity of two fingers that vary their touch positions. The rotation quantity of a display corresponds to the operation quantity of two fingers of which one finger is fixed and the other finger rotates around the former on the screen.

Recently, there is known a technology referred to as terminal mode. The technology connects a vehicular display apparatus having a touch panel with a mobile terminal having a touch panel, interoperates these devices with each other, and enables the vehicular display apparatus to use mobile terminal functions. The terminal mode displays a screen of a touch panel (hereinafter referred to as a mobile touch panel) provided for the mobile terminal on a touch panel (hereinafter referred to as a vehicular touch panel) provided for the vehicular display apparatus. In the terminal mode, a touch operation on the vehicular touch panel enables the mobile terminal to perform an operation equivalent to a touch operation on the mobile touch panel.

In more detail, the terminal mode allows the mobile terminal to transmit pixel-based color information (pixel information) to the vehicular display apparatus. Based on the pixel information, the vehicular display apparatus displays a screen of the mobile touch panel on the vehicular touch panel. The vehicular display apparatus also transmits information about the touch position on the vehicular touch panel to the mobile terminal. Based on the position information, the mobile terminal performs an operation corresponding to the touch operation on the mobile touch panel.
Patent Document 1: Japanese Unexamined Patent Publication No. 2001-290585 corresponding to US 2002/0036618

The terminal mode enables the vehicular display apparatus to perform the mobile terminal function capable of coordinate conversion of displays on the screen using gesture input (hereinafter referred to as coordinate conversion gesture input) that causes coordinate conversions such as parallel shift, enlargement, reduction, and rotation. However, the related art degrades the usability. Details will be described below.

Display coordinates on the mobile terminal screen needs to be converted so as to be displayed on the vehicular touch panel. For this purpose, the vehicular display apparatus needs to transmit position information to the mobile terminal, that is, position information corresponding to changes in touch positions on the vehicular touch panel during coordinate conversion gesture input. The vehicular display apparatus also needs to allow the mobile terminal to perform the coordinate conversion that is equivalent to that for the coordinate conversion gesture input and is performed for the mobile touch panel.

Conventionally, as described above, the quantity of converting display coordinates on the mobile touch panel screen corresponds to the amount of change in touch positions (i.e., the operation quantity of touch operations) during the gesture input. The user must adjust the operation quantity of touch operations while confirming a change in the display on the vehicular touch panel screen so that the user can convert the targeted quantity of coordinates corresponding to a display on the mobile terminal screen to be displayed on the vehicular touch panel. However, the user cannot continue to watch the vehicular touch panel while he or she concentrates on driving the vehicle. It is difficult to convert the targeted quantity of coordinates and degrade the usability.

### SUMMARY

It is an object of the present disclosure to provide a display apparatus for a vehicle and an information display system capable of improving the usability so that the display apparatus is connected to a mobile terminal and is capable of using mobile terminal functions.

According to a first aspect of the present disclosure, a display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus includes: a vehicular touch panel mounted on the vehicle and displaying a vehicle-side image corresponding to received screen data of the mobile terminal. The display apparatus specifies a mobile position of the mobile touch panel, which corresponds to a touch position of the vehicular touch panel when a user touches the vehicular touch panel to operate the display apparatus. The display apparatus transmits information indicative of a specified mobile position of the mobile touch panel. The display apparatus further includes: a detector that detects a slide operation of the touch position of the vehicular touch panel when the user slides the touch position of the vehicular touch panel, and that detects a slid touch position of the vehicular touch panel; a conversion mode determination device that determines a type of display coordinate conversion based on the slide operation detected by the detector, and that determines a direction of the display coordinate conversion based on the touch position and the slid touch position detected by the detector; and a pseudo-operation information generation device that generates pseudo-operation information indicating the mobile position and a slid mobile position, which corresponds to the slid touch position of the vehicular touch panel, assuming that an operation for providing the type and the direction of the display coordinate conversion determined by the conversion mode determination device is performed on the mobile touch panel by a predetermined constant quantity. The display apparatus transmits the pseudo-operation information to the mobile terminal.

The above apparatus can improve the usability for users to use functions of the mobile terminal on the vehicular display apparatus while the mobile terminal is connected to the vehicular display apparatus.

According to a second aspect of the present disclosure, a display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus includes: a vehicular touch panel mounted on the vehicle and displaying a vehicle-side image corresponding to received screen data of the mobile terminal. The display apparatus specifies a first mobile position of the mobile touch panel, which corresponds to a first touch position of the vehicular touch panel when a user firstly touches the vehicular touch panel to operate the display apparatus. The display apparatus transmits information indicative of a specified first mobile position of the mobile touch panel. The display apparatus further includes: a detector that detects a re-touch operation of the vehicular touch panel when the user secondly touches the vehicular touch panel to operate the display apparatus after the user firstly touches the vehicular touch panel, and that detects a second touch position of the vehicular touch panel, which is different from the first touch position; a first superimpose display device that controls the vehicular touch panel to superimpose an icon over the vehicle-side image when the user firstly touches the vehicular touch panel, the icon being used for the user to specify a type and a direction of display coordinate conversion; a conversion mode determination device that determines based on the second touch position detected by the detector whether the user selects the icon, and that determines the type and the direction of display coordinate conversion so as to correspond to the icon selected by the user when the conversion mode determination device determines that the user selects the icon; and a pseudo-operation information generation device that generates pseudo-operation information indicating the first mobile position and a converted first mobile position, which is prepared assuming that an operation for providing the type and the direction of the display coordinate conversion determined by the conversion mode determination device is performed on the mobile touch panel by a predetermined constant quantity. The display apparatus transmits the pseudo-operation information to the mobile terminal.

In the above apparatus, the vehicular touch panel enables the coordinate conversion that is available by simultaneously operating two locations on a mobile terminal screen even though the vehicular touch panel cannot simultaneously detect multiple operation positions. The versatility is improved.

According to a third aspect of the present disclosure, a display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus includes: a vehicular touch panel mounted on the vehicle and displaying a vehicle-side image corresponding to received screen data of the mobile terminal. The display apparatus specifies a first mobile position of the mobile touch panel, which corresponds to a first touch position of the vehicular touch panel when a user firstly touches the vehicular touch panel to operate the display apparatus. The display apparatus transmits information indicative of a specified first mobile position of the mobile touch panel. The display apparatus further includes: a detector that detects a re-touch operation of the vehicular touch panel when the user secondly touches the vehicular touch panel to operate the display apparatus after the user firstly touches the vehicular touch panel, and that detects a second touch position of the vehicular touch panel, which is different from the first touch position; a second superimpose display device that controls the vehicular touch panel to superimpose a predetermined frame over the vehicle-side image when the user firstly touches the vehicular touch panel, the predetermined frame enclosing the first touch position of the vehicular touch panel; a conversion mode determination device that determines a positional relationship between the frame and the second touch position based on the second touch position detected by the detector and a placement position of the frame, and that determines a type and a direction of display coordinate conversion in accordance with determined positional relationship; and a pseudo-operation information generation device that generates pseudo-operation information indicating the first mobile position and a converted first mobile position, which is prepared assuming that an operation for providing the type and the direction of the display coordinate conversion determined by the conversion mode determination device is performed on the mobile touch panel by a predetermined constant quantity. The display apparatus transmits the pseudo-operation information to the mobile terminal.

In the above apparatus, the vehicular touch panel enables the coordinate conversion that is available by simultaneously operating two locations on a mobile terminal screen even though the vehicular touch panel cannot simultaneously detect multiple operation positions. The versatility is improved.

According to a fourth aspect of the present disclosure, an information display system includes: a mobile terminal having a touch panel; and the display apparatus according to one of first to third aspects. The mobile terminal receives the pseudo-operation information transmitted from the display apparatus. The mobile terminal controls the mobile touch panel to perform the operation for providing the type and the direction of the display coordinate conversion to the mobile image by the predetermined constant quantity according to the pseudo-operation information.

The above system enables to improve the usability for users to use functions of the mobile terminal on the vehicular display apparatus while the mobile terminal is connected to the vehicular display apparatus.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing the schematic configuration of an information display system;

FIG. 2 is a block diagram showing the schematic configuration of a smart phone;

FIG. 3 is a block diagram showing the schematic configuration of a vehicular display apparatus;

FIG. 4A is a schematic diagram showing a ratio between a smart phone display area on a screen of a vehicular touch panel portion and a screen of a mobile touch panel portion; and FIG. 4B is a schematic diagram showing correspondence relation between coordinates for operation positions on a screen of the vehicular touch panel portion and coordinates on a screen of the mobile touch panel portion;

FIG. 5 is a sequence diagram showing an initialization process that enables specification of an operation target position;

FIG. 6 is a flowchart showing a process in a vehicle-side control portion in normal operation mode;

FIG. 7 is a flowchart showing a process in the vehicle-side control portion in order to switch between the normal operation mode and simplified operation mode;

FIG. 8 is a flowchart showing a process for various settings in the vehicle-side control portion when the simplified operation mode is active;

FIG. 9 is a flowchart showing a process in the vehicle-side control portion when terminal mode is used;

FIG. 10A is a schematic diagram showing a slide operation for enlargement; FIG. 10B is a schematic diagram illustrating calculation of ending point coordinates for simplified input; and FIG. 10C is a schematic diagram illustrating specification of an operation target position for enlargement;

FIG. 11A is a schematic diagram showing a slide operation for reduction; FIG. 11B is a schematic diagram illustrating calculation of ending point coordinates for simplified input; and FIG. 11C is a schematic diagram illustrating specification of an operation target position for reduction;

FIG. 12 is a flowchart showing a process in the vehicle-side control portion when terminal mode is used;

FIG. 13 is a flowchart showing a process in a mobile-side control portion when terminal mode is used;

FIG. 14A is a schematic diagram showing operation position changes when a relatively small operation quantity of pinch-out operation is performed on the vehicular touch panel portion; FIG. 14B is a schematic diagram showing operation position changes when a relatively large operation quantity of pinch-out operation is performed on the vehicular touch panel portion; and FIG. 14C is a schematic diagram showing operation position changes in a slide operation detected on the smart phone based on position information and pseudo-operation information transmitted from the vehicular display apparatus;

FIG. 15 is a flowchart showing a process in the vehicle-side control portion according to modification 1 when terminal mode is used;

FIG. 16 is a schematic diagram showing a coordinate conversion specification icon;

FIGS. 17A through 17C are schematic diagrams showing operation position changes in slide operations detected on the smart phone when the coordinate conversion specification icon is touched;

FIG. 18 is a flowchart showing a process in the vehicle-side control portion according to modification 2 when terminal mode is used;

FIG. 19 is a schematic diagram showing a coordinate conversion specification frame; and

FIGS. 20A through 20C are schematic diagrams showing operation position changes in slide operations detected on the smart phone in accordance with positional relation between placement positions of the coordinate conversion specification frame and operation positions of a subsequent touch operation.

### DESCRIPTION OF EMBODIMENTS

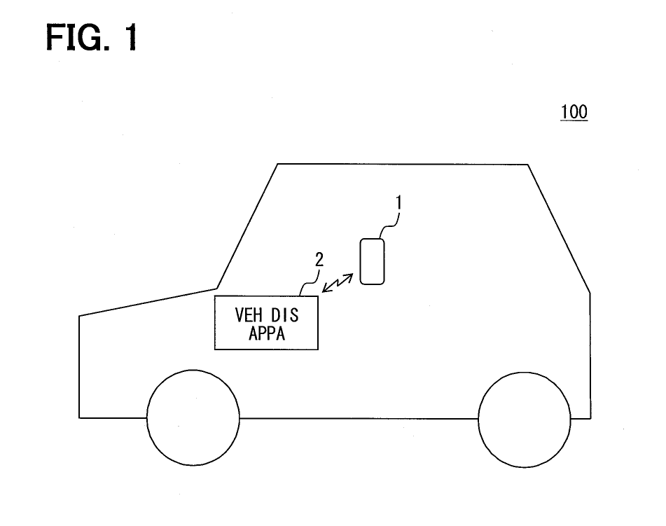

Embodiments will be described in further detail with reference to the accompanying drawings. FIG. 1 is a block diagram showing the schematic configuration of an information display system 100. The information display system 100 shown in FIG. 1 includes a smart phone 1 and a vehicular display apparatus 2. In the information display system 100, the smart phone 1 generates screen data to be displayed on its screen and transmits the generated screen data to the vehicular display apparatus 2. The vehicular display apparatus 2 displays a screen corresponding to the screen data. An input operation on the vehicular display apparatus 2 operates the smart phone 1.

The smart phone 1 represents a so-called touch-panel mobile telephone capable of input operations using a touch panel integrated with operational segments on the screen. Similarly to ordinary touch-panel mobile telephones, the smart phone 1 has a telephone function, a mail function, and a map function. The smart phone 1 is equivalent to a mobile terminal.

The embodiment describes examples using the touch-panel mobile telephone as the mobile terminal but is not limited thereto. The mobile terminal may be otherwise configured if it has a function of communicating with the vehicular display apparatus 2 and is equipped with a touch panel. For example, the mobile terminal may be configured as a PDA (Personal Digital Assistant) or a tablet computer.

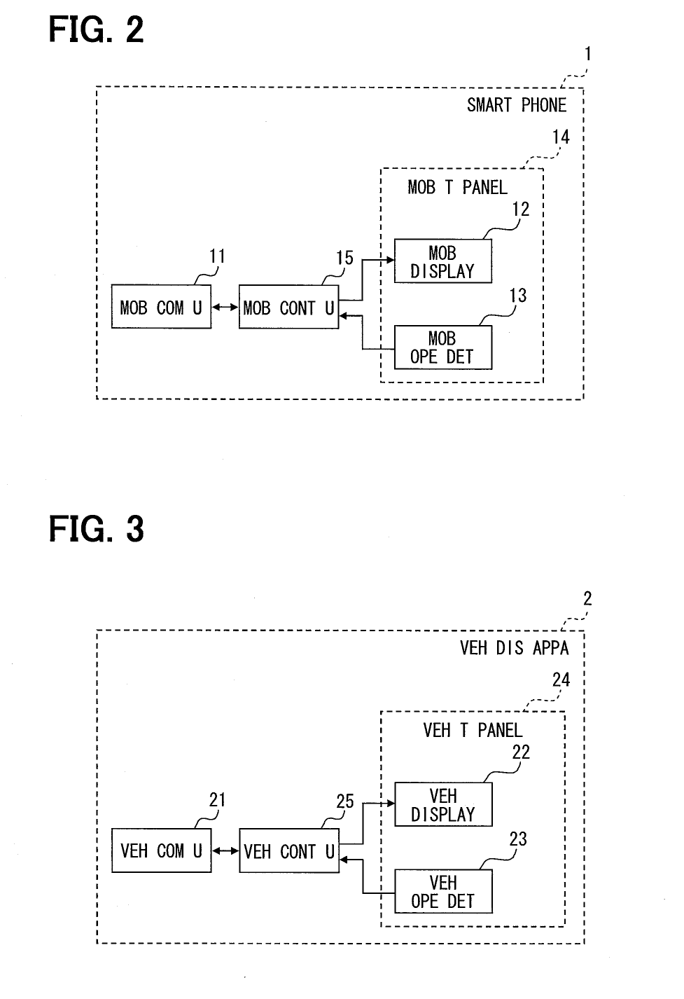

The following describes the schematic configuration of the smart phone 1 with reference to FIG. 2. For the sake of convenience, the following omits description of configurations about functions that are included in ordinary touch-panel mobile telephones and are irrelevant to the description. FIG. 2 is a block diagram showing the schematic configuration of the smart phone 1. As shown in FIG. 2, the smart phone 1 includes a mobile-side communication portion 11, a mobile touch panel portion 14 including a mobile-side display portion 12 and a mobile-side operation detection portion 13, and a mobile-side control portion 15.

The mobile-side control portion 11 performs communication (hereinafter referred to as BT communication) according to Bluetooth (registered trademark) with the vehicular display apparatus 2. The communication between the smart phone 1 and the vehicular display apparatus 2 may comply with near field communication standards such as ZigBee (registered trademark) and wireless LAN standards such as IEEE802.11 as well as Bluetooth (registered trademark). Further, the communication between the smart phone 1 and the vehicular display apparatus 2 may be configured as wired communication using USB connection, for example, as well as the wireless communication.

The mobile-side display portion 12 displays screens corresponding to various application programs (hereinafter referred to as applications) for the smart phone 1 and is capable of full-color display, for example. The mobile-side display portion 12 may use a liquid crystal display, an organic EL display, or a plasma display, for example.

The mobile-side operation detection portion 13 uses a touch sensor integrated with the mobile-side display portion 12. The mobile-side operation detection portion 13 detects at which position on the screen of the mobile-side display portion 12 a press operation (hereinafter referred to as a touch operation) has been performed. The mobile-side operation detection portion 13 supplies the mobile-side control portion 15 with coordinates corresponding to the operation position.

The mobile touch panel portion 14 includes the mobile-side display portion 12 and the mobile-side operation detection portion 13 integrated with each other. The mobile touch panel portion 14 displays screens on the mobile-side display portion 12 in accordance with instructions from the mobile-side control portion 15. When an operation is performed on the screen, the mobile touch panel portion 14 uses the mobile-side operation detection portion 13 to detect the operation position on the screen. The mobile touch panel portion 14 supplies the mobile-side control portion 15 with the coordinates corresponding to the operation position. The mobile touch panel portion 14 is equivalent to a mobile terminal touch panel.

The mobile touch panel portion 14 may represent a so-called multi-touch panel capable of simultaneously detecting multiple operation positions on the screen or a touch panel incapable of the same. The following description assumes the mobile touch panel portion 14 to be a multi-touch panel according to the embodiment. The mobile touch panel portion 14 may be available as capacitive, resistive, optical, or other types. The embodiment uses the capacitive type.

The mobile-side control portion 15 is configured as an ordinary computer and contains, though not shown, a conventional CPU, ROM, EEPROM, RAM, I/O, and a bus line connecting these components, for example. The mobile-side control portion 15 performs various processes based on various types of information supplied from the mobile-side communication portion 11 and the mobile touch panel portion 14.

For example, the mobile-side control portion 15 performs an application program (hereinafter referred to as an application). The mobile-side control portion 15 generates screen data for displaying a screen according to the application on the mobile touch panel portion 14 and displays the screen corresponding to the screen data on the mobile touch panel portion 14. Applications may be previously stored in the ROM or may be downloaded from a server using a communication means (not shown) via communication networks such as mobile telephone networks.

Based on coordinates supplied from the mobile touch panel portion 14, the mobile-side control portion 15 determines at which position of the screen displayed on the mobile touch panel portion 14 an operation was performed. The mobile-side control portion 15 performs a process corresponding to a position (hereinafter referred to as an operation position) where the operation was performed. For example, the mobile-side control portion 15 performs a process corresponding to a button indication at the operation position.

In addition, the mobile-side control portion 15 detects the number of operation positions or a slide operation by the user based on coordinates supplied from the mobile touch panel portion 14. The mobile-side control portion 15 performs processes for coordinate conversion such as parallel shift, scale conversion (enlargement or reduction), and rotation of display of images such as maps and photos and objects other than button indications on the screen. For example, the mobile-side control portion 15 converts coordinates for an image or an object other than the button indication at the operation position.

The following describes a process (hereinafter referred to as a coordinate conversion) of performing coordinate conversion such as parallel shift, scale conversion, and rotation of display of images on the screen based on the number of detected operation positions or detected slide operations. Detection of operation positions and slide operations will be described first.

When a touch operation is performed on the mobile touch panel portion 14, the mobile touch panel portion 14 supplies coordinates at the operation position where the touch operation was performed. For example, if the touch operation is performed at one location, coordinates for that location are supplied. If the touch operation is performed at two locations, coordinates for the two locations are supplied. The mobile-side control portion 15 detects the number of operation positions based on the number of supplied coordinates.

The mobile-side control portion 15 assumes the touch operation to be continuous if the mobile-side operation detection portion 13 continuously supplies coordinates. For example, the touch operation is assumed to be continuous unless no coordinate input continues for a specified time period. The specified time period can be set to any value.

There may be a case where the touch operation is assumed to be continuous and different coordinates are successively input within a specified time period while no increase is detected in the number of operation positions. In such a case, the mobile-side control portion 15 detects that a slide operation is performed on the mobile touch panel portion 14. The slide operation signifies an input method of sliding the operation position while the touch operation remains active on the mobile touch panel portion 14. The specified time period may be set to any value, e.g., one second.

The mobile-side control portion 15 assumes a starting point corresponding to the coordinates for the operation position where the touch operation started. The mobile-side control portion 15 then combines nearest coordinates with each other to detect a movement locus of operation positions, for example. In addition, the mobile-side control portion 15 detects a slide operation ending point. For example, the slide operation ending point may represent an ending point of the locus that is detected immediately before the coordinate input stops continuing for a specified time period or longer because the touch operation is released. Furthermore, the slide operation ending point may represent a locus ending point whose position remains unchanged for a specified time period or longer. If there are multiple operation positions, the mobile-side control portion 15 combines nearest coordinates with each other to detect movement loci of the operation positions.

The following describes an example of the coordinate conversion process. The mobile-side control portion 15 may detect one operation position and detect a slide operation whose starting point corresponds to the operation position. In such a case, the mobile-side control portion 15 parallel shifts an image displayed on the screen correspondingly to the operation direction and the operation quantity of the slide operation. In detail, the mobile-side control portion 15 converts coordinates for the starting point of the slide operation into coordinates for the ending point thereof. The mobile-side control portion 15 applies the equivalent conversion to the display of the image.

The mobile-side control portion 15 may detect two operation positions and detect a slide operation whose starting points correspond to both operation positions. In such a case, the mobile-side control portion 15 applies scale conversion to the display of an image on the screen depending on whether the slide operation increases or decreases a distance between both operation positions and how much the slide operation varies the distance between both. In detail, the mobile-side control portion 15 calculates a distance between the starting points based on coordinates for the starting points of the slide operations. The mobile-side control portion 15 also calculates a distance between the ending points based on coordinates for the ending points of the slide operations. The mobile-side control portion 15 then calculates a ratio of the distance between the ending points to the distance between the starting points. The mobile-side control portion 15 performs conversion so as to enlarge or reduce the screen image by that ratio. Specifically, the mobile-side control portion 15 performs conversion to enlarge the screen image if the ratio is greater than 1. The mobile-side control portion 15 performs conversion to reduce the screen image if the ratio is smaller than 1.

The scale conversion converts the coordinates for the center between ending points of the slide operations into the coordinates for the screen center. The similar conversion may be applied to the display of an image on the screen so as to parallel shift the center between the ending points of the slide operations to the screen center. The following description assumes that the mobile-side control portion 15 also performs the parallel shift during the scale conversion.

The mobile-side control portion 15 may detect two operation positions and detect the slide operation that uses only one of the operation positions as the starting point. In such a case, the mobile-side control portion 15 rotates the display of an image on the screen in accordance with the operation direction and the operation quantity of the fixed operation position for the slide operation. In detail, the mobile-side control portion 15 converts the image display in the same manner as converting the starting point coordinates into the ending point coordinates for the slide operation around the coordinates for the fixed operation position.

In addition, mobile-side control portion 15 performs a pairing process to enable BT communication with the vehicular display apparatus 2 using the mobile-side communication portion 11. The BT communication is established between the smart phone 1 and the vehicular display apparatus 2 to enable the terminal mode. The mobile-side control portion 15 then allows the mobile-side communication portion 11 to transmit screen data or display area information, generated for display on the mobile touch panel portion 14, to the vehicular display apparatus 2.

The screen data signifies pixel-based color information, for example. The display area information represents a screen size equivalent to the width (W pixels) multiplied by the height (H pixels) or a resolution. The terminal mode displays the screen of the smart phone 1 on the vehicular display apparatus 2 and operates the smart phone 1 based on input operations on the vehicular display apparatus 2. For example, the terminal mode may be enabled or disabled in accordance with a user's input operation on the mobile touch panel portion 14. Alternatively, the terminal mode may be automatically enabled when the BT communication is established between the smart phone 1 and the vehicular display apparatus 2 and connects both with each other.

While the terminal mode is selected, the mobile-side control portion 15 is supplied with position information or pseudo-operation information from the vehicular display apparatus 2 via the mobile-side communication portion 11. Based on the supplied information, the mobile-side control portion 15 determines at which position on the screen displayed on the mobile touch panel portion 14 the operation was performed. The mobile-side control portion 15 performs a process corresponding to the position where the operation was performed. This will be described later in detail.

Returning back to FIG. 1, the vehicular display apparatus 2 is fixed to or is portably placed in a vehicle such as a car. The vehicular display apparatus 2 is used in the vehicle and displays images. For example, the vehicular display apparatus 2 is equivalent to a vehicular display apparatus, a vehicular navigation system, or a so-called display audio system. The display audio system signifies a vehicular display apparatus that includes only basic functions such as a display function, an audio reproduction function, and a communication function with the smart phone 1 and provides versatile functions in cooperation with the smart phone 1. A vehicular navigation system integrated with a display may be used as the vehicular display apparatus 2. A set of a display and a vehicular navigation system without display may be used as the vehicular display apparatus 2. According to the embodiment, the following describes an example of the vehicular display apparatus 2 as a display audio system.

The following describes a schematic configuration of the vehicular display apparatus 2 with reference to FIG. 3. For the sake of convenience, the following omits description of configurations about functions that are included in the vehicular display apparatus 2 and are irrelevant to the description. FIG. 3 is a block diagram showing the schematic configuration of the vehicular display apparatus 2. As shown in FIG. 3, the vehicular display apparatus 2 includes a vehicle-side communication portion 21, a vehicular touch panel portion 24 including a vehicle-side display portion 22 and a vehicle-side operation detection portion 23, and a vehicle-side control portion 25.

The vehicle-side communication portion 21 performs BT communication with the smart phone 1, for example. As described above, the communication between the vehicular display apparatus 2 and the smart phone 1 may be wireless or wired. The vehicle-side communication portion 21 receives display area information or screen data transmitted from mobile-side communication portion 11 and supplies the received information or data to the vehicle-side control portion 25. The vehicle-side communication portion 21 transmits position information or pseudo-operation information output from the vehicle-side control portion 25 to the mobile-side communication portion 11 in accordance with instructions from the vehicle-side control portion 25.

The vehicle-side display portion 22 displays screens in accordance with instructions from the vehicle-side control portion 25 and is capable of full-color display, for example. The vehicle-side display portion 22 may use a liquid crystal display, an organic EL display, or a plasma display. The vehicle-side operation detection portion 23 uses a touch sensor integrated with the vehicle-side display portion 22. The vehicle-side operation detection portion 23 detects at which position on the screen of the vehicle-side display portion 22 a touch operation was performed. The vehicle-side operation detection portion 23 supplies the coordinates for the operation position to the vehicle-side control portion 25.

The vehicular touch panel portion 24 is an integration of the vehicle-side display portion 22 and the vehicle-side operation detection portion 23. The vehicular touch panel portion 24 displays screens on the vehicle-side display portion 22 in accordance with instructions from the vehicle-side control portion 25. When an operation is performed on the screen, the vehicular touch panel portion 24 uses the vehicle-side operation detection portion 23 to detect an operation position. The vehicular touch panel portion 24 supplies the operation position coordinates to the vehicle-side control portion 25. The vehicular touch panel portion 24 is equivalent to a vehicular touch panel.

The following description assumes the vehicular touch panel portion 24 to be a multi-touch panel capable of simultaneously displaying multiple operation positions on the screen. The vehicular touch panel portion 24 is assumed to be compatible with the capacitive type, for example.

The vehicle-side control portion 25 is configured as an ordinary computer and contains, though not shown, a known CPU, ROM, EEPROM, RAM, I/O, and a bus line connecting these components, for example. The vehicle-side control portion 25 performs various processes based on various types of information supplied from the vehicle-side communication portion 21 and the vehicle-side operation detection portion 23.

The vehicle-side control portion 25 receives screen data (hereinafter referred to as mobile-originated screen data) from the smart phone 1 via the vehicle-side communication portion 21. The vehicle-side control portion 25 then generates an image (hereinafter referred to as a vehicle-generated image) in accordance with the mobile-originated screen data and outputs the image to the vehicle-side display portion 22. The vehicle-side control portion 25 allows the vehicle-side display portion 22 to display the screen corresponding to the mobile-originated screen data. The vehicle-side control portion 25 generates vehicle-generated image based on the display area information transmitted from the smart phone 1, for example. The vehicle-generated image results from converting the size or the resolution of the mobile-originated screen data into the size or the resolution of the screen for the vehicle-side display portion 22.

The configuration according to the embodiment converts the size or the resolution corresponding to mobile-originated screen data into the size or the resolution corresponding to the screen of the vehicle-side display portion 22 based on the display area information transmitted from the smart phone 1. Another example of the configuration may predetermine a fixed value as a conversion ratio for the size or the resolution of mobile-originated screen data, previously store the fixed value in nonvolatile memory such as the ROM in the vehicle-side control portion 25, and perform the conversion according to the fixed value. In this case, the smart phone 1 may not transmit the display area information.

Based on the coordinates supplied from the vehicular touch panel portion 24, the vehicle-side control portion 25 determines at which position on the screen displayed on the vehicular touch panel portion 24 the operation was performed. The vehicle-side control portion 25 performs a process corresponding to the operation position. Based on the coordinates supplied from the vehicular touch panel portion 24, the vehicle-side control portion 25 detects the number of operation positions, a slide operation, or an ending point of the slide operation. The detection is performed in the same manner as that for the mobile-side control portion 15. The vehicle-side control portion 25 is equivalent to a change detection means.

When the terminal mode is selected, the vehicle-side control portion 25 allows the vehicle-side communication portion 21 to transmit position information or pseudo-operation information to the smart phone 1. The information corresponds to a detection result such as the number of operation positions or the slide operation.

For example, the vehicle-side control portion 25 specifies an operation target position if a touch operation is detected. The operation target position is equivalent to coordinates that are located on the screen of the mobile touch panel portion 14 of the smart phone 1 and correspond to the coordinates for the operation position of the touch operation. A method of specifying the operation target position may convert the size of the mobile-originated screen data so that the conversion reverses that used to generate the vehicle-generated image.

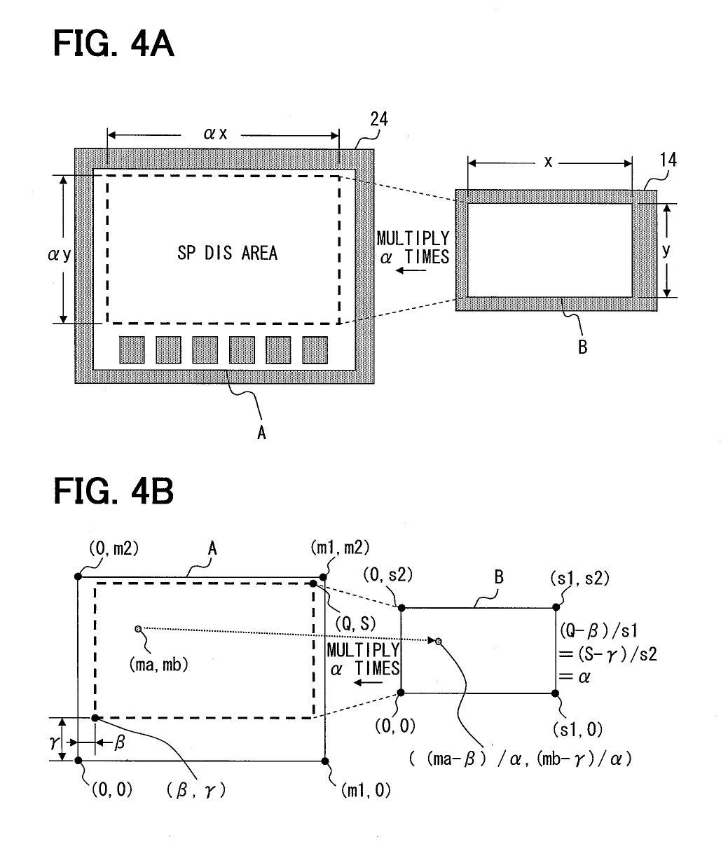

The following describes in detail the specification of the operation target position with reference to FIGS. 4A and 4B. FIG. 4A is a schematic diagram showing a ratio between a smart phone display area on a screen of the vehicular touch panel portion 24 and a screen of the mobile touch panel portion 14. The smart phone display area is contained in the screen of the vehicular touch panel portion 24 and displays an image to be displayed on the screen of the mobile touch panel portion 14. FIG. 4B is a schematic diagram showing correspondence relation between coordinates for operation positions on a screen of the vehicular touch panel portion 24 and coordinates on a screen of the mobile touch panel portion 14.

The following describes an example that uses the same aspect ratio for the smart phone display area on the screen of the vehicular touch panel portion 24 and the screen of the mobile touch panel portion 14. As shown in FIG. 4A, for example, the screen (A) of the vehicular touch panel portion 24 contains the rectangular smart phone display area (illustrated as a rectangle in broken line). A vertical length (αy) of the smart phone display area is a times as long as a vertical length (y) of a rectangular screen (B) of the mobile touch panel portion 14. A horizontal length (αx) of the smart phone display area is a times as long as a horizontal length (x) of the screen of the mobile touch panel portion 14. The value a denotes a ratio of the actual vertical length and horizontal length of the smart phone display area in the vehicular touch panel portion 24 to the actual vertical length and horizontal length of the screen in the mobile touch panel portion 14.

With reference to FIG. 4B, the following describes correspondence relation between coordinates for the operation position on the screen of the vehicular touch panel portion 24 and coordinates on the screen of the mobile touch panel portion 14 when the ratio as shown in FIG. 4A is maintained between the screen of the mobile touch panel portion 14 and the smart phone display area of the vehicular touch panel portion 24. According to the embodiment, the following description assumes that the rectangular screen of the vehicular touch panel portion 24 contains coordinates (0, 0) at the bottom left corner, coordinates (0, m2) at the top left corner, coordinates (m1, m2) at the top right corner, and coordinates (m1, 0) at the bottom right corner. The rectangular smart phone display area of the vehicular touch panel portion 24 is assumed to contain coordinates (β, γ) at the bottom left corner and coordinates (Q, S) at the top right corner. Coordinate β denotes an offset value for the left end line of the smart phone display area from the left end line of the screen of the vehicular touch panel portion 24. Coordinate γ denotes an offset value for the bottom end line of the smart phone display area from the bottom end line of the screen of the vehicular touch panel portion 24. The rectangular screen of the mobile touch panel portion 14 is assumed to contain coordinates (0, 0) at the bottom left corner, coordinates (0, s2) at the top left corner, coordinates (s1, s2) at the top right corner, and coordinates (s1, 0) at the bottom right corner.

For example, let us suppose that the vehicle-side control portion 25 detects a touch operation at point (ma, mb) on the smart phone display area of the vehicular touch panel portion 24. Then, the vehicle-side control portion 25 specifies the operation target position as coordinates ((ma−β)/α, (mb−γ)/α). That is, the vehicular touch panel portion 25 specifies the operation target position as a result of shifting a point on the smart phone display area by the offset value for the smart phone display area with reference to the screen of the vehicular touch panel portion 24 and reducing the point by the ratio of the smart phone display area to the screen of the mobile touch panel portion 14.

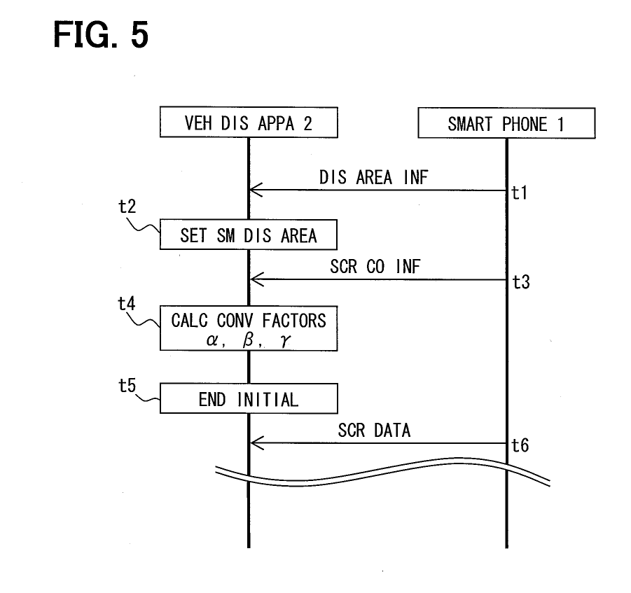

With reference to FIG. 5, the following describes an initialization process that enables specification of an operation target position. FIG. 5 is a sequence diagram showing the initialization process that enables specification of the operation target position. The initialization process is assumed to start when the smart phone 1 and the vehicular display apparatus 2 are connected and the terminal mode starts to be used, for example.

The smart phone 1 transmits display area information to the vehicular display apparatus 2 (t1). For example, the screen of the mobile touch panel portion 14 has the resolution of 800×480 dots. The smart phone 1 then transmits the resolution of 800×480 dots as the display area information. In this case, coordinates (800, 0) on the screen correspond to coordinates (s1, 0) in FIG. 4B and coordinates (0, 480) correspond to coordinates (0, s2) in FIG. 4B.

The vehicular display apparatus 2 (the vehicle-side control portion 25 in more detail) receives the display area information and then settles the smart phone display area for the vehicular touch panel portion 24 (t2). The smart phone display area is sized so that it can display the screen of the smart phone 1 as viewable and manipulable as possible. For example, smart phone display area sizes may be predetermined for resolutions of the smart phone 1. A proper size may be selected in accordance with the resolution of the smart phone 1. There may be a case where the vehicular display apparatus 2 and the smart phone 1 use the same resolution (e.g., 800×480 WVGA) and the entire screen of the vehicular touch panel portion 24 displays the screen of the mobile touch panel portion 14. Even in such a case, however, the displayed sizes may be different from each other if the screens use different dot pitch sizes.

The smart phone 1 transmits coordinate information about the screen of the smart phone 1 to the vehicular display apparatus 2 (t3). The coordinate information about the screen of the smart phone 1 just needs to be able to specify coordinates at four corners of the screen of the mobile touch panel portion 14. For example, the information may contain coordinates (0, 0) at the bottom left corner and coordinates (s1, s2) at the top right corner of the screen of the mobile touch panel portion 14 or may contain only coordinates (s1, s2) at the top right corner.

The vehicular display apparatus 2 (the vehicle-side control portion 25 in more detail) receives the coordinate information about the screen of the smart phone 1 and then calculates conversion factors α, β, and γ in order to specify the operation target position (t4). To do this, the vehicle-side control portion 25 acquires coordinates that belong to the screen of the vehicular touch panel portion 24 and correspond to the bottom left corner and the top right corner of the smart phone display area. According to the example of the embodiment, the vehicle-side control portion 25 acquires coordinates (β, γ) at the bottom left corner and coordinates (Q, S) at the top right corner.

According to the example of the embodiment, the vehicle-side control portion 25 calculates the conversion factor 13 corresponding to the x-coordinate value β and the conversion factor γ corresponding to the γ-coordinate value γ in the coordinates (β, γ) at the bottom left corner. The vehicle-side control portion 25 operates an equation (Q−β)/s1=(S−γ)/s2=α to find the conversion factor α based on the coordinates (Q, S) at the top right corner of the smart phone display area and the coordinates (s1, s2) at the screen of the smart phone 1. The initialization process terminates when the conversion factors α, 13, and γ are found (t5).

After the initialization process terminates, the smart phone 1 transmits screen data to the vehicular display apparatus 2 (t6). This screen data is generated to be displayed on the mobile touch panel portion 14. The vehicular display apparatus 2 receives the screen data (i.e., the above-mentioned mobile-originated screen data) and then generates vehicle-generated image in accordance with the mobile-originated screen data. The smart phone display area displays the screen represented by the mobile-originated screen data.

The terminal mode, when selected, enables two operation modes, that is, a normal operation mode and a simplified operation mode. The normal operation mode converts coordinates for image display on the screen of the mobile touch panel portion 14 in accordance with the operation quantity on the screen of the vehicular touch panel portion 24. To do this, the vehicular display apparatus 2 continuously transmits the specified operation target position to the smart phone 1. The operation target position is equivalent to coordinates that belong to the screen of the mobile touch panel portion 14 and correspond to coordinates for the operation position on the screen of the vehicular touch panel portion 24.

The normal operation mode transmits the specified operation target position to the smart phone 1 while the operation position belongs to the smart phone display area of the vehicular touch panel portion 24. According to the example of the embodiment, the normal operation mode transmits the specified operation target position to the smart phone 1 under the condition of 0≦ma≦m1 and 0≦mb≦m2 as well as β≦ma≦Q and γ≦mb≦S.

The normal operation mode performs a smart phone display area outside process if the operation position is located outside the smart phone display area on the screen of vehicular touch panel portion 24. The smart phone display area outside process may perform operations of the vehicular display apparatus 2 that are allocated to an area outside the smart phone display area. The area may be allocated to operational instructions for a hardware switch of the smart phone 1. In such a case, the position information indicating an operation on the area may be transmitted to the smart phone 1.

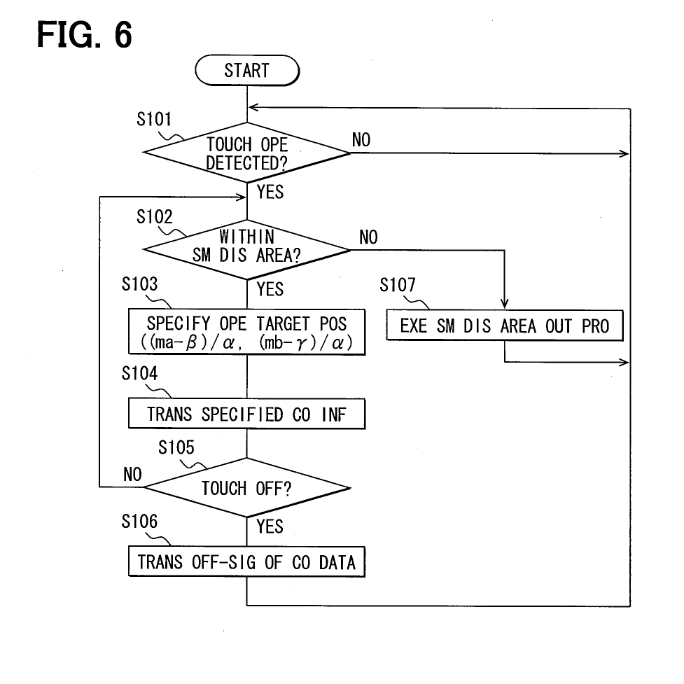

With reference to FIG. 6, the following describes a process flow in the vehicular display apparatus 2 in the normal operation mode. FIG. 6 is a flowchart showing a process in the vehicle-side control portion 25 in the normal operation mode. The flow in FIG. 6 is assumed to start when the normal operation mode starts. The following description assumes that the initialization process has been completed.

At step S101, the process detects a touch operation on the screen of the vehicular touch panel portion 24 and detects the number of operation positions for the touch operation. The process proceeds to step S102 if the touch operation is detected (YES at step S101). In the following description, the example of the embodiment assumes that the touch operation corresponds to one location indicated by coordinates (ma, mb). The process returns to step S101 and repeats the flow if no touch operation is detected (NO at step S101).

At step S102, the process determines whether the operation position for the touch operation belongs to the smart phone display area. The example of the embodiment assumes the operation position to be within the smart phone display area if coordinates of the detected operation position satisfy 0≦ma≦m1 and 0≦mb≦m2 as well as β≦ma≦Q and γ≦mb≦S. The process proceeds to step S103 if the operation position is within the smart phone display area according to the determination (YES at step S102). The process proceeds to step S107 if the operation position is outside the smart phone display area according to the determination (NO at step S102).

At step S103, the process specifies an operation target position, that is, coordinates that belong to the screen of the mobile touch panel portion 14 and correspond to the coordinates for the operation position on the screen of the vehicular touch panel portion 24. To specify the operation target position, the conversion factors α, β, and γ calculated in the above-mentioned initialization process are used to convert the coordinates for the operation position on the screen of the vehicular touch panel portion 24 into coordinates on the screen of the mobile touch panel portion 14. In detail, the coordinates (ma, mb) are converted into the coordinates ((ma−β)/α, (mb−γ)/α).

At step S104, the process allows the vehicle-side communication portion 21 to transmit the position information, that is, information about the coordinates specified as the operation target position, to the smart phone 1 and then proceeds to step S105. Multiple operation positions (e.g., two positions) may be detected. In such a case, the position information to be transmitted contains coordinates for the operation target positions corresponding to coordinates for the two operation positions.

At step S105, the process determines whether the touch operation terminates to activate a touch-off state. For example, the touch-off state may become active if the vehicular touch panel portion 24 stops detecting a touch operation. The process proceeds to step S106 if the touch-off state is active according to the determination (YES at step S105). The process returns step S102 and repeats the flow if the touch-off state is inactive according to the determination (NO at step S105).

The vehicle-side control portion 25 may determine that the touch operation continues. That is, the vehicle-side control portion 25 may detect that the touch operation does not terminate and is followed by a slide operation on the vehicular touch panel portion 24. In such a case, the vehicle-side control portion 25 periodically specifies an operation target position corresponding to the operation position for the continued touch operation. The vehicle-side control portion 25 successively transmits coordinates for the specified operation target position to the smart phone 1. Any value is specifiable as a time interval to periodically specify the operation target position during the slide operation. For example, the time interval may be predetermined in consideration of natural display or response rate and the throughput. An example time interval may indicate 100 ms or 15 fps (Frames Per Second).

At step S106, the process specifies the operation target position for the operation position that activated the touch-off state. Coordinates for the specified operation target position are provided as position information (off-data) about the ending point of the touch operation. An off-signal indicates the end of the touch operation. The vehicle-side communication portion 21 transmits the off-data and the off-signal to the smart phone 1. The process returns to step S101 and repeats the flow. The ending point of the slide operation, if any, corresponds to the operation position that activated the touch-off state. At step S107, the process performs the above-mentioned smart phone display area outside process, and then returns to step S101 to repeat the flow.

By contrast, the simplified operation mode converts coordinates for image display on the screen of the mobile touch panel portion 14 based on a specified quantity regardless of the operation quantity on the screen of the vehicular touch panel portion 24.

For example, the normal operation mode may be enabled if a vehicle mounted with the vehicular display apparatus 2 stops. The normal operation mode may automatically switch to the simplified operation mode if the vehicle is running. Based on a signal from a vehicle sensor (not shown), the vehicle-side control portion 25 may determine whether the vehicle stops or is running. The vehicle-side control portion 25 may determine that the vehicle is running if it indicates a specified speed or higher. The vehicle-side control portion 25 may determine that the vehicle stops if it does not. The specified speed may be available as a lowest speed (e.g., 5 km/h) the vehicle speed sensor can detect. The simplified operation mode may be always active while the terminal mode is selected.

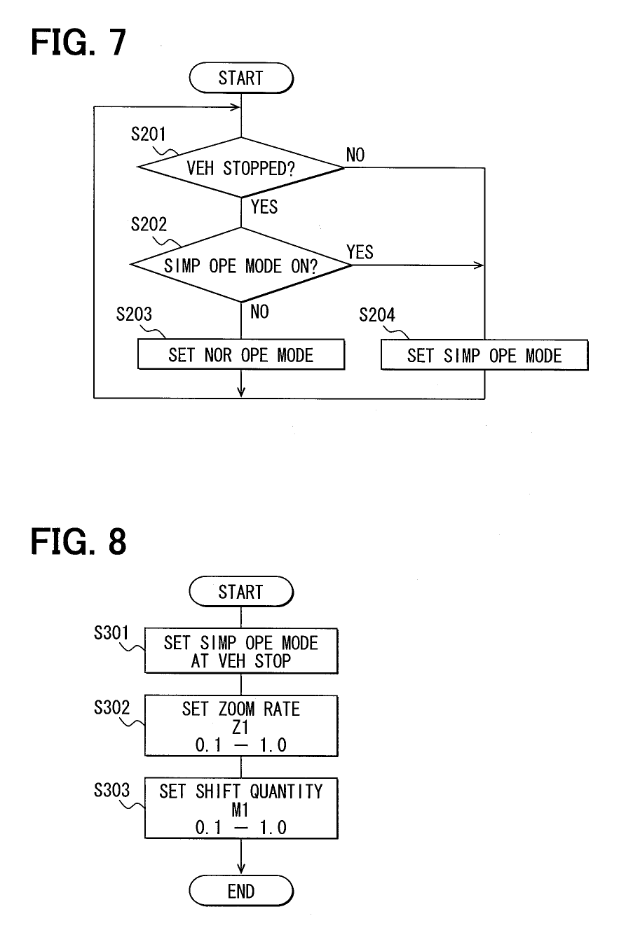

The normal operation mode may switch to the simplified operation mode and vice versa according as a user selects the normal operation mode or the simplified operation mode. With reference to FIG. 7, the following describes an example process of switching between the normal operation mode and simplified operation mode. FIG. 7 is a flowchart showing a process in the vehicle-side control portion 25 in order to switch between the normal operation mode and simplified operation mode. For example, the flow in FIG. 7 is assumed to start when the terminal mode becomes active, and is assumed to terminate when the terminal mode becomes inactive.

At step S201, the process determines whether the vehicle mounted with the vehicular display apparatus 2 stops or is running. As described above, the process may determine that the vehicle is running if it indicates a specified speed or higher. The process may determine that the vehicle stops if it does not. The process proceeds to step S202 if the vehicle stops according to the determination (YES at step S201). The process proceeds to step S204 if the vehicle is running according to the determination (NO at step S201).

At step S202, the process determines whether the simplified operation mode turns on. For example, a user turns on or off the simplified operation mode using the vehicular touch panel portion 24 while the vehicle stops. The simplified operation mode may be assumed to turn on if the user turns it on. The simplified operation mode may be assumed to turn off if the user turns it off.

The process proceeds to step S204 if the simplified operation mode turns on according to the determination (YES at step S202). The process proceeds to step S203 if the simplified operation mode turns off according to the determination (NO at step S202). At step S203, the process enables the normal operation mode and then returns to step S201 to repeat the flow. At step S204, the process enables the simplified operation mode and then returns to step S201 to repeat the flow.

In the simplified operation mode, the vehicle-side control portion 25 may detect that a slide operation is performed on the vehicular touch panel portion 24 subsequently to the touch operation. In such a case, the vehicle-side control portion 25 determines the type and the direction of converting coordinates for the screen display based on the number of operation positions and coordinates for the starting point and the ending point of the slide operation. The vehicle-side control portion 25 is equivalent to a conversion mode determination means. The starting point of the slide operation may be assumed to be the operation position to start the slide operation. A process of determining the type and the direction of converting coordinates will be described later in detail.

After determining the coordinate conversion type and direction, the vehicle-side control portion 25 applies the coordinate conversion of the specified type and direction to the coordinates for the slide operation starting point as much as a specified quantity (constant quantity) to determine coordinates (hereinafter referred to as converted coordinates). The constant quantity denotes any specifiable fixed value. The vehicle-side control portion 25 specifies coordinates that correspond to the converted coordinates and belong the screen of the mobile touch panel portion 14 of the smart phone 1. The vehicle-side control portion 25 generates information about the specified coordinates and transmits the information to the smart phone 1 from the vehicle-side communication portion 21. According to the embodiment, the information about the specified coordinates is referred to as pseudo-operation information. The vehicle-side control portion 25 is equivalent to a pseudo-operation information generation means. The constant quantity may contain different fixed values for the coordinate conversion types. The user may be able to specify different fixed values for the coordinate conversion types.

With reference to FIG. 8, the following describes a process of setting coordinate conversion quantities in the simplified operation mode. FIG. 8 is a flowchart showing a process for various settings in the vehicle-side control portion 25 when the simplified operation mode is active. The flow in FIG. 8 is assumed to start when a user uses the vehicular touch panel portion 24 to select a setup menu in the simplified operation mode, for example.

At step S301, the process allows the vehicular touch panel portion 24 to display a setup screen for performing the simplified operation mode setup while the vehicle stops (hereinafter simply referred to as the simplified operation mode setup). The process performs the simplified operation mode setup in accordance with a user input from the vehicular touch panel portion 24. For example, the process turns on the simplified operation mode setup if the user input enables a selection that turns on the simplified operation mode setup. The process turns off the simplified operation mode setup if the user input enables a selection that turns off the simplified operation mode setup. The process then proceeds to step S302.

At step S302, the process allows the vehicular touch panel portion 24 to display a setup screen that configures a conversion quantity (hereinafter referred to as a zooming quantity) Z1 for enlargement or reduction as the coordinate conversion. The process configures the zooming quantity Z1 in accordance with a user input from the vehicular touch panel portion 24. The process then proceeds to step S303. For example, the zooming quantity Z1 is assumed to specify values ranging from 0.1 to 1.0.

At step S303, the process allows the vehicular touch panel portion 24 to display a setup screen that configures a conversion quantity (hereinafter referred to as a shift quantity) M1 for parallel shift as the coordinate conversion. The process configures the shift quantity M1 in accordance with a user input from the vehicular touch panel portion 24. The process then terminates the flow. For example, the shift quantity M1 is assumed to specify values ranging from 0.1 to 1.0. The vehicle-side control portion 25 is equivalent to a setup means.

According to the configuration of the embodiment, the processes are performed to configure the simplified operation mode, the zooming quantity Z1, and then the shift quantity M1 in this order, but are not limited thereto. The processes may be performed in the other orders. Further, the process may allow the vehicular touch panel portion 24 to display a setup screen that configures a conversion quantity (hereinafter referred to as a rotation quantity) for rotation as the coordinate conversion. The process may also configure the quantity in accordance with a user input from the vehicular touch panel portion 24.

A method similar to that used to specify the operation target position may be used to specify coordinates that correspond to the converted coordinates and belong to the screen of the mobile touch panel portion 14 of the smart phone 1. The method may perform the conversion reverse to that used to convert the size of the mobile-originated screen data and generate a vehicle-generated image. To specify the operation target position, the above-mentioned conversion factors α, β, and γ may be used to convert the converted coordinates on the screen of the vehicular touch panel portion 24 into coordinates on the screen of the mobile touch panel portion 14. In detail, converted coordinates (ma4, mb4) are converted into coordinates ((ma4−β)/α, (mb4−γ)/α).

For example, let us suppose that a slide operation is detected at two operation positions. Then, the vehicle-side control portion 25 transmits the pseudo-operation information corresponding to coordinates at the ending points for the slide operations. Let us suppose that a slide operation is detected at only one of two operation positions. Then, the vehicle-side control portion 25 transmits not only the pseudo-operation information corresponding to coordinates at the ending point for the slide operation but also pseudo-operation information about coordinates that correspond to the coordinates for the fixed operation position and belong to the screen of the mobile touch panel portion 14 of the smart phone 1.

The pseudo-operation information according to the embodiment is equivalent to information about coordinates for the ending point of the slide operation on the mobile touch panel portion 14. In this case, it is assumed that a slide operation is performed on the mobile touch panel portion 14 in order to apply the coordinate conversion to the screen display as much as the constant quantity. It is also assumed that the vehicle-side control portion 25 settled the type and the direction of the coordinate conversion. Accordingly, when the smart phone 1 receives the pseudo-operation information, its mobile-side control portion 15 determines that a slide operation was performed up to the ending point corresponding to the coordinates indicated by the pseudo-operation information. The mobile-side control portion 15 applies the coordinate conversion for the constant quantity to image display on the screen of the mobile touch panel portion 14 so that the coordinate conversion corresponds to the slide operation. The screen of the vehicular touch panel portion 24 also reflects the screen where the coordinate conversion was performed as much as the constant quantity.

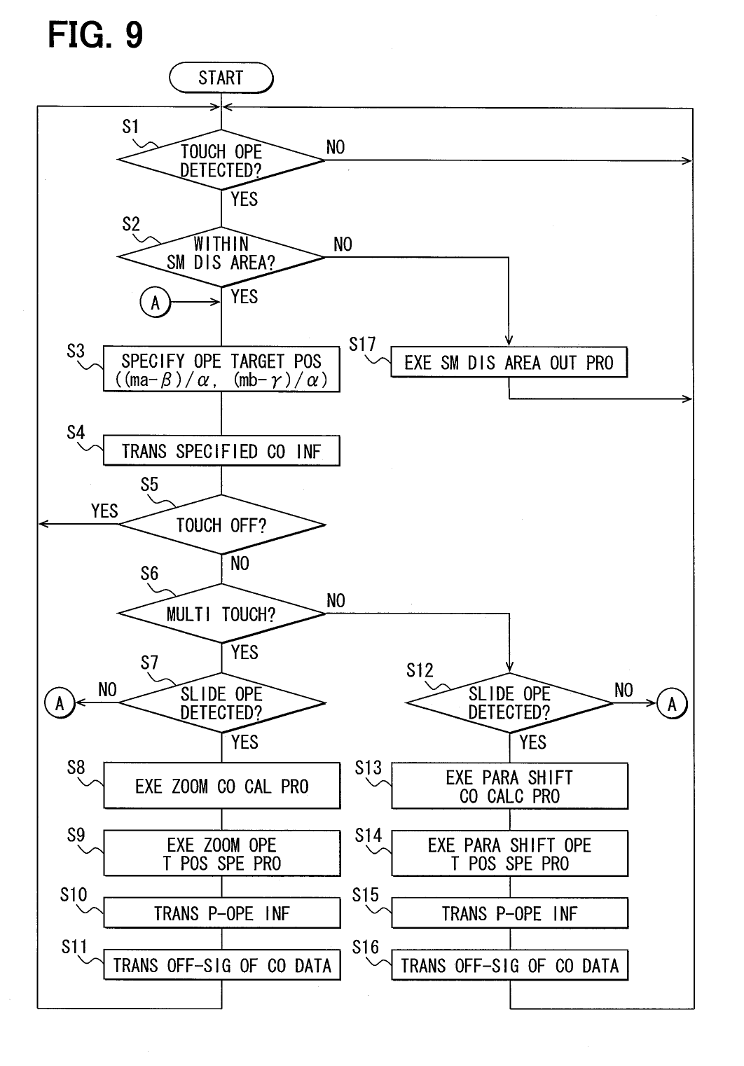

With reference to FIG. 9, the following describes an example process flow of coordinate conversion for the image display on the screens of the vehicular display apparatus 2 and the smart phone 1 when the terminal mode is used. FIG. 9 is a flowchart showing a process in the vehicle-side control portion 25 when the terminal mode is used. The flow in FIG. 9 is assumed to start when the vehicle-side communication portion 21 receives mobile-originated screen data transmitted from the smart phone 1 and the vehicle-side display portion 22 displays the screen represented by the mobile-originated screen data.

At step S1, similarly to step S101 above, the process detects a touch operation on the screen of the vehicular touch panel portion 24 and detects the number of operation positions for the touch operation. The process proceeds to step S2 if the touch operation is detected (YES at step S1). The process returns to step S1 and repeats the flow if no touch operation is detected (NO at step S1).

At step S2, similarly to step S102 above, the process determines whether the operation position for the touch operation belongs to the smart phone display area. The process proceeds to step S3 if the operation position is within the smart phone display area according to the determination (YES at step S2). The process proceeds to step S18 if the operation position is outside the smart phone display area according to the determination (NO at step S2). At step S3, similarly to step S103 above, the process specifies the operation target position by using the conversion factors α, β, and γ and converting coordinates (ma, mb) into the coordinates ((ma−β)/α, (mb−γ)/α). The process then proceeds to step S4.

At step S4, similarly to step S104, the process allows the vehicle-side communication portion 21 to transmit the coordinate information specified as the operation target position to the smart phone 1. The process then proceeds to step S5. At step S4, the process transmits the position information corresponding to one or two operation positions for the touch operation depending on the number of detected operation positions.

At step S5, similarly to step S105 above, the process determines whether the touch operation terminates to activate a touch-off state. The process proceeds to step S6 if the touch-off state is active according to the determination (YES at step S5). The process returns step S1 and repeats the flow if the touch-off state is inactive according to the determination (NO at step S5).

At step S6, the process determines whether a multi-touch operation occurred. In detail, the process assumes occurrence of a multi-touch operation if step S1 detects multiple operation positions for the touch operation. On the other hand, the process assumes occurrence of a single-touch operation if step S1 detects one operation position for the touch operation.

As an example of the embodiment, the following description assumes occurrence of a multi-touch operation if step S1 detects two operation positions for the touch operation. The process proceeds to step S7 if the multi-touch operation occurs according to the determination (YES at step S6). The process proceeds to step S12 if the single-touch operation occurs according to the determination (NO at step S6).

At step S7, the process detects a slide operation, that is, the touch operation that does not stop and continues after it was detected at step S1. The process proceeds to step S8 if the slide operation was detected (YES at step S7). The process returns to step S3 if no slide operation is detected (NO at step S7). The process specifies an operation target position for the operation position and repeats the flow.

At step S8, the process performs a zoom coordinate calculation process and then proceeds to step S9. The zoom coordinate calculation process settles a slide direction of the detected slide operation. The slide direction can be settled based on coordinates for the operation position (initial point) of the touch operation detected at step S1 and coordinates for an operation position changed due to the slide operation following the touch operation. The coordinates for the operation position changed due to the slide operation may be selected so as to be nearer to the operation position for the touch operation.

Coordinates for the operation position changed due to the slide operation correspond to those for the operation position changed first from the initial point due to the slide operation, not coordinates for the operation position immediately before the touch-off state. This is a precondition for the following description.

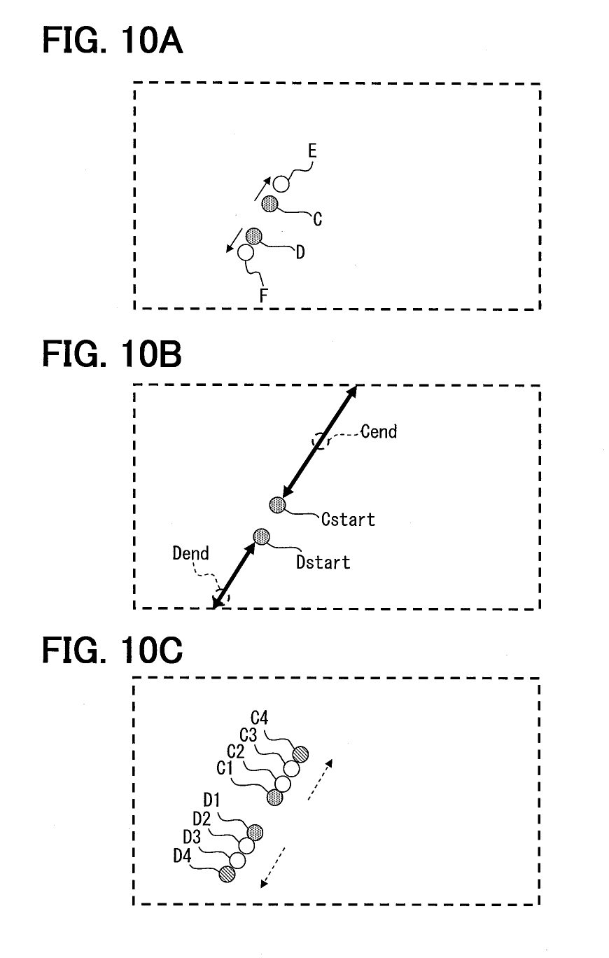

The zoom coordinate calculation process performs an enlargement process if the slide operation occurs according to the determination in a direction to make two initial points distant from each other based on the settled slide direction. The slide operation can occur according to the determination in a direction to make two initial points distant from each other if a distance between two operation positions changed due to the slide operation is greater than a distance between the two initial points, for example. The following describes the enlargement process with reference to FIGS. 10A and 10B.

FIG. 10A is a schematic diagram showing the slide operation for enlargement. The rectangular area enclosed in broken line represents the smart phone display area. The arrows represent slide directions of the actual slide operation. Reference symbols C and D represent initial points. Reference symbols E and F represent operation positions changed due to the slide operation. Coordinate points such as the initial points are illustrated in the drawings for convenience of the description and are not actually displayed. As shown in FIG. 10A, the enlargement process is performed if the slide operation occurs according to the determination in a direction to make two initial points (C and D) distant from each other.

The enlargement process calculates a distance (hereinafter referred to as a display area end distance) between the initial point and the end of the smart phone display area. In detail, the process calculates the distance of a line that is drawn from the initial point coordinates to the end of the smart phone display area in the settled slide direction. If two multi-touch operations occur, the process calculates the display area end distance for each of the two initial points.

The process multiplies the longer one of the calculated display area end distances by a predetermined zooming quantity Z1 to calculate a conversion quantity in the simplified operation mode. In the case of Z1=0.5, for example, the process multiplies the display area end distance by 0.5 to calculate the conversion quantity.

After calculating the conversion quantity, the process calculates ending point coordinates (that is, the above-mentioned converted coordinates) for simplified input based on the calculated conversion quantity, the settled slide direction, and the initial point coordinates. With reference to FIG. 10B, the following describes calculation of ending point coordinates for the simplified input. FIG. 10B is a schematic diagram illustrating calculation of ending point coordinates for the simplified input. The rectangular area enclosed in broken line represents the smart phone display area. The arrows represent display area end distances. There are two initial points Cstart and Dstart. Let us suppose that the display area end distance from Cstart is longer than the display area end distance from Dstart.

Again, the display area end distance from Cstart is longer than the display area end distance from Dstart. To calculate the conversion quantity, the process multiplies the display area end distance from Cstart by Z1 (e.g., 0.5). The process extends the line from the Cstart coordinates in the slide direction settled for Cstart as long as the conversion quantity. The process thereby calculates ending point coordinates (Cend) corresponding to Cstart for the simplified input. The process extends the line from the Dstart coordinates in the slide direction settled for Dstart as long as the conversion quantity. The process thereby calculates ending point coordinates (Dend) corresponding to Dstart for the simplified input.

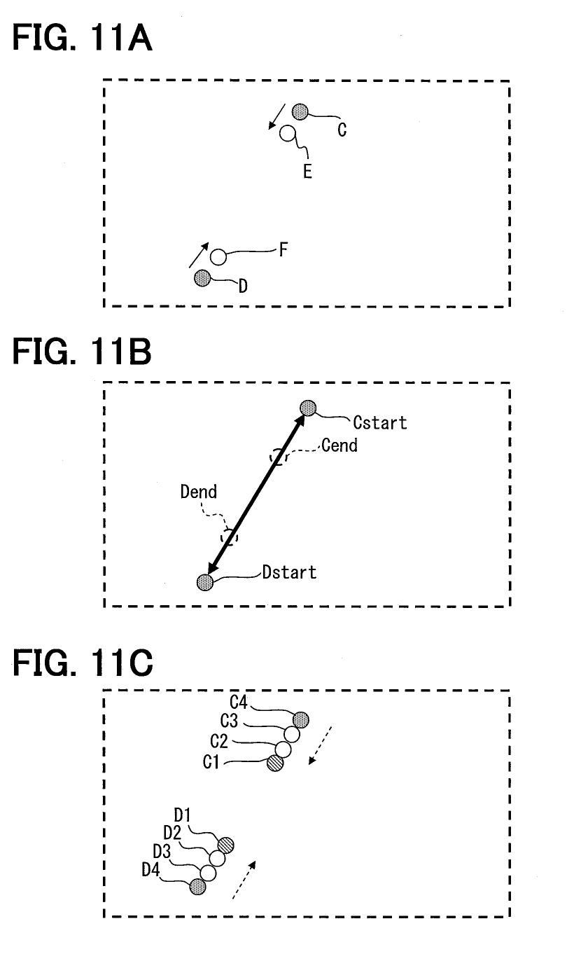

The zoom coordinate calculation process performs a reduction process if the slide operation occurs according to the determination in a direction to make two initial points closer to each other. The reduction process will be described below. The slide operation can occur according to the determination in a direction to make two initial points closer to each other if a distance between two operation positions changed due to the slide operation is smaller than a distance between the two initial points, for example. The following describes the reduction process with reference to FIGS. 11A and 11B.

FIG. 11A is a schematic diagram showing a slide operation for reduction. The rectangular area enclosed in broken line represents the smart phone display area. The arrows represent slide directions of the actual slide operation. Reference symbols C and D represent initial points. Reference symbols E and F represent operation positions changed due to the slide operation. Coordinate points such as the initial points are illustrated in the drawings for convenience of the description and are not actually displayed. As shown in FIG. 11A, the reduction process is performed if the slide operation occurs according to the determination in a direction to make two initial points (C and D) closer to each other.

Based on coordinates for the two initial points, the reduction process calculates a distance between both initial points (hereinafter referred to as an inter-initial-point distance). The process multiplies a half of the calculated inter-initial-point distance by the predetermined zooming quantity Z1 to calculate the conversion quantity in the simplified operation mode. In the case of Z1=0.5, for example, the process multiplies the half of the inter-initial-point distance by 0.5 to calculate the conversion quantity.

After calculating the conversion quantity, the process calculates ending point coordinates (that is, the above-mentioned converted coordinates) for simplified input based on the calculated conversion quantity, the settled slide direction, and the initial point coordinates. With reference to FIG. 11B, the following describes calculation of ending point coordinates for the simplified input. FIG. 11B is a schematic diagram illustrating calculation of ending point coordinates for the simplified input. The rectangular area enclosed in broken line represents the smart phone display area. The arrow represents an inter-initial-point distance. There are two initial points Cstart and Dstart.

The process multiplies the inter-initial-point distance for Cstart and Dstart by Z1 (e.g., 0.5) to calculate the conversion quantity. The process extends the line from the Cstart coordinates in the slide direction settled for Cstart as long as the conversion quantity. The process thereby calculates ending point coordinates (Cend) corresponding to Cstart for the simplified input. The process extends the line from the Dstart coordinates in the slide direction settled for Dstart as long as the conversion quantity. The process thereby calculates ending point coordinates (Dend) corresponding to Dstart for the simplified input.

At step S9 in FIG. 9, the process performs a zoom operation target position specification process and then proceeds to step S10. The zoom operation target position specification process generates pseudo-slide data from the initial point to the ending point coordinates for simplified input. The pseudo-slide data is equivalent to coordinates at a virtual operation position (hereinafter referred to as a virtual change coordinate point) that is located on a line connecting the initial point with the ending point coordinates for simplified input. For example, the pseudo-slide data is generated so as to place the initial point, the virtual change coordinate point, and the ending point coordinates for simplified input at equal intervals.

No pseudo-slide data is generated if the virtual change coordinate point exceeds the smart phone display area. In this case, for example, it may be preferable to extend the line connecting the initial point with the ending point coordinates to the end of the smart phone display area, find coordinates of an intersection point at the end thereof, and redefine the coordinates as new ending point coordinates for simplified input.

Increasing a value of the zooming quantity Z1 may increase the number of pieces of pseudo-slide data. As other examples, the number of pieces of pseudo-slide data may be increased in accordance with an increase in the distance from the initial point to the ending point coordinates for simplified input or may be fixed to a predetermined value. According to the embodiment, the following description assumes that each initial point is provided with two pieces of pseudo-slide data

The zoom operation target position specification process then specifies an operation target position for the initial point, the pseudo-slide data, and the ending point coordinates for simplified input. That is, the operation target position is equivalent to coordinates that belong to the screen of the mobile touch panel portion 14 and correspond to the coordinates of the operation position on the screen of the vehicular touch panel portion 24. In detail, to specify the operation target position, the process uses the conversion factors α, β, and γ calculated in the above-mentioned initialization and converts the initial point, the pseudo-slide data, and the ending point coordinates for simplified input.

FIGS. 10C and 11C are used to describe specification of an operation target position for enlargement and reduction. First, FIG. 10C is used to describe specification of an operation target position for enlargement. FIG. 10C is a schematic diagram illustrating specification of an operation target position for enlargement.

In FIG. 10C, reference symbols C1 and D1 denote initial points (equivalent to Cstart and Dstart above). Reference symbols C4 and D4 denote ending point coordinates for simplified input (equivalent to Cend and Dend above). Reference symbols C2, C3, D2, and D3 denote virtual change coordinate points. Reference symbols C1, C2, C3, and C4 are placed in this order from C1 along the slide direction (indicated by the arrowed broken line). Reference symbols D1, D2, D3, and D4 are placed in this order from D1 along the slide direction (indicated by the arrowed broken line).

The following description assumes coordinates C1 (ma1, mb1), C2 (ma2, mb2), C3 (ma3, mb3), C4 (ma4, mb4), D1 (ma5, mb5), D2 (ma6, mb6), D3 (ma7, mb7), and D4 (ma8, mb8).

As described above, the conversion factors α, β, and γ are used for conversion to specify the operation target positions as follows. The operation target positions for C1 through C4 are specified as ((ma1−β)/α, (mb1−γ)/α), ((ma2−β)/α, (mb2−γ)/α), ((ma3−β)/α, (mb3−γ)/α), and ((ma4−β)/α, and (mb4−γ)/α). The operation target positions for D1 through D4 are specified as ((ma5−β)/α, (mb5−γ)/α), ((ma6−β)/α, (mb6−γ)/α), ((ma7−β)/α, (mb7−γ)/α), and ((ma8−β)/α, (mb8−γ)/α).

FIG. 11C is used to describe specification of an operation target position for reduction. FIG. 11C is a schematic diagram illustrating specification of an operation target position for reduction. In FIG. 11C, reference symbols C4 and D4 denote initial points (equivalent to Cstart and Dstart above). Reference symbols C1 and D1 denote ending point coordinates for simplified input (equivalent to Cend and Dend above). Reference symbols C3, C2, D3, and D2 denote virtual change coordinate points. Reference symbols C4, C3, C2, and C1 are placed in this order from C4 along the slide direction (indicated by the arrowed broken line). Reference symbols D4, D3, D2, and D1 are placed in this order from D4 along the slide direction (indicated by the arrowed broken line).

The following description assumes coordinates C4 (ma4, mb4), C3 (ma3, mb3), C2 (ma2, mb2), C1 (ma1, mb1), D4 (ma8, mb8), D3 (ma7, mb7), D2 (ma6, mb6), and D1 (ma5, mb5).

As described above, the conversion factors α, β, and γ are used for conversion to specify the operation target positions as follows. The operation target positions for C4 through C1 are specified as ((ma4−β)/α, (mb4−γ)/α), ((ma3−β)/α, (mb3−γ)/α), ((ma2−β)/α, (mb2−γ)/α), ((ma1−β)/α, and (mb1−γ)/α). The operation target positions for D4 through D1 are specified as ((ma8−β)/α, (mb8−γ)/α), ((ma7−β)/α, (mb7−γ)/α), ((ma6−β)/α, (mb6−γ)/α), ((ma5−β)/α, and (mb5−γ)/α).

At step S10 in FIG. 9, the process assumes the coordinates specified in the zoom operation target position specification process to be pseudo-operation information and transmits this information to the smart phone 1 from the vehicle-side communication portion 21 and then proceeds to step S11. In detail, the process successively transmits the pseudo-operation information about the initial point, the pseudo-operation information about the virtual change coordinate point, and the pseudo-operation information about the ending point coordinates for simplified input at a specified time interval. Any value is specifiable as the specified time interval. For example, the time interval may be predetermined in consideration of natural display or response rate and the throughput of the smart phone 1. An example time interval may indicate 100 ms or 15 fps (Frames Per Second).

The operation target position corresponding to the initial point is equivalent to an operation starting point. The pseudo-operation information about the virtual change coordinate point is equivalent to an operation intermediate point. The pseudo-operation information about the ending point coordinates for simplified input is equivalent to an operation ending point.

The above-mentioned enlargement process as an example first transmits ((ma1−β)/α, (mb1−γ)/α) as the pseudo-operation information about C1, ((ma5−β)/α, (mb5−γ)/α) as the pseudo-operation information about D1, and the on-signal indicating the continued touch operation to the smart phone 1. After the specified time interval, the process then transmits ((ma2−β)/α, (mb2−γ)/α) as the pseudo-operation information about C2, ((ma6−β)/α, (mb6−γ)/α) as the pseudo-operation information about D2, and the on-signal indicating the continued touch operation to the smart phone 1.

After another specified time interval, the process transmits ((ma3−β)/α, (mb3−γ)/α) as the pseudo-operation information about C3, ((ma7−β)/α, (mb7−γ)/α) as the pseudo-operation information about D3, and the on-signal indicating the continued touch operation to the smart phone 1. Finally, after yet another specified time interval, the process transmits ((ma4−β)/α, (mb4−γ)/α) as the pseudo-operation information about C4, ((ma8−β)/α, (mb8−γ)/α) as the pseudo-operation information about D4, and the on-signal indicating the continued touch operation to the smart phone 1.

The above-mentioned reduction process as an example transmits ((ma4−β)/α, (mb4−γ)/α) as the pseudo-operation information about C4, ((ma8−β)/α, (mb8−γ)/α) as the pseudo-operation information about D4, and the on-signal indicating the continued touch operation to the smart phone 1. After the specified time interval, the process then transmits ((ma3−β)/α, (mb3−γ)/α) as the pseudo-operation information about C3, ((ma7−β)/α, (mb7−γ)/α) as the pseudo-operation information about D3, and the on-signal indicating the continued touch operation to the smart phone 1.

After another specified time interval, the process transmits ((ma2−β)/α, (mb2−γ)/α) as the pseudo-operation information about C2, ((ma6−β)/α, (mb6−γ)/α) as the pseudo-operation information about D2, and the on-signal indicating the continued touch operation to the smart phone 1. Finally, after yet another specified time interval, the process transmits ((ma1−β)/α, (mb1−γ)/α) as the pseudo-operation information about C1, ((ma5−β)/α, (mb5−γ)/α) as the pseudo-operation information about D1, and the on-signal indicating the continued touch operation to the smart phone 1.

At step S11, the process transmits an off-signal to the smart phone 1 from the vehicle-side communication portion 21 and returns to step S1 to repeat the flow. In detail, the above-mentioned enlargement process as an example transmits ((ma4−β)/α, (mb4−γ)/α) as the pseudo-operation information about C4, ((ma8−β)/α, (mb8−γ)/α) as the pseudo-operation information about D4, and the off-signal indicating termination of the touch operation to the smart phone 1. The above-mentioned reduction process as an example transmits ((ma1−β)/α, (mb1−γ)/α) as the pseudo-operation information about C1, ((ma5−β)/α, (mb5−γ)/α) as the pseudo-operation information about D1, and the off-signal indicating termination of the touch operation to the smart phone 1.

At step S12, the process detects a slide operation following the touch operation detected at step S1. If the slide operation is detected (YES at step S12), the process proceeds to step S13. If no slide operation is detected (NO at step S12), the process returns to step S3, specifies an operation target position for the operation position, and repeats the flow.

At step S14, the process performs a parallel shift coordinate calculation process and then proceeds to step S15. Similarly to the zoom coordinate calculation process, the parallel shift coordinate calculation process determines a slide direction of the detected slide operation. The parallel shift coordinate calculation process calculates the display area end distance, that is, a distance from the initial point to the end of the smart phone display area. In detail, the process calculates the distance of a line that is drawn from the initial point coordinates to the end of the smart phone display area in the settled slide direction. The process multiplies the calculated display area end distance by a predetermined parallel shift quantity M1 to calculate a conversion quantity in the simplified operation mode. In the case of M1=0.5, for example, the process multiplies the display area end distance by 0.5 to calculate the conversion quantity.

After calculating the conversion quantity, the process calculates ending point coordinates (that is, the above-mentioned converted coordinates) for simplified input based on the calculated conversion quantity, the settled slide direction, and the initial point coordinates. This process is the same as the above-mentioned enlargement.

Coordinates for the operation position changed due to the slide operation correspond to those for the operation position changed first from the initial point due to the slide operation, not coordinates for the operation position immediately before the touch-off state. This is a precondition for the following description.

At step S15, the process performs a parallel shift operation target position specification process and then proceeds to step S16. Similarly to the parallel shift operation target position specification process, the parallel shift operation target position specification process generates pseudo-slide data from the initial point to the ending point coordinates for simplified input. Increasing a value of the parallel shift quantity M1 may increase the number of pieces of pseudo-slide data. As other examples, the number of pieces of pseudo-slide data may be increased in accordance with an increase in the distance from the initial point to the ending point coordinates for simplified input or may be fixed to a predetermined value.

Similarly to the parallel shift operation target position specification process, the parallel shift operation target position specification process then specifies an operation target position for the initial point, the pseudo-slide data, and the ending point coordinates for simplified input. That is, the operation target position is equivalent to coordinates that belong to the screen of the mobile touch panel portion 14 and correspond to the coordinates of the operation position on the screen of the vehicular touch panel portion 24. In detail, to specify the operation target position, the process uses the conversion factors α, β, and γ calculated in the above-mentioned initialization and converts the initial point, the pseudo-slide data, and the ending point coordinates for simplified input.

For example, let us assume that C1 represents the initial point; C2 and C3 represent virtual change coordinate points; and C4 represents the ending point coordinates for simplified input. The corresponding coordinates are assumed to be C1 (ma1, mb1), C2 (ma2, mb2), C3 (ma3, mb3), and C4 (ma4, mb4). Then, the operation target positions are specified as: C1 ((ma1−β)/α, (mb1−γ)/α), C2 ((ma2−β)/α, (mb2−γ)/α), C3 ((ma3−β)/α, (mb3−γ)/α), and C4 ((ma4−β)/α, (mb4−γ)/α).

At step S16, the process assumes the coordinates specified in the parallel shift operation target position specification process to be pseudo-operation information and transmits this information to the smart phone 1 from the vehicle-side communication portion 21 and then proceeds to step S17. In detail, the process successively transmits the pseudo-operation information about the initial point, the pseudo-operation information about the virtual change coordinate point, and the pseudo-operation information about the ending point coordinates for simplified input at a specified time interval. Any value is specifiable as the specified time interval. For example, the time interval may be predetermined in consideration of natural display or response rate and the throughput of the smart phone 1.

The above-mentioned example first transmits ((ma1−β)/α, (mb1−γ)/α) as the pseudo-operation information about C1 and the on-signal indicating the continued touch operation to the smart phone 1. After the specified time interval, the process then transmits ((ma2−β)/α, (mb2−γ)/α) as the pseudo-operation information about C2 and the on-signal indicating the continued touch operation to the smart phone 1. After another specified time interval, the process transmits ((ma3−β)/α, (mb3−γ)/α) as the pseudo-operation information about C3 and the on-signal indicating the continued touch operation to the smart phone 1. Finally, after yet another specified time interval, the process transmits ((ma4-β)/α, (mb4−γ)/α) as the pseudo-operation information about C4 and the on-signal indicating the continued touch operation to the smart phone 1.

At step S17, the process transmits an off-signal to the smart phone 1 from the vehicle-side communication portion 21 and returns to step S1 to repeat the flow. In detail, the above-mentioned example transmits ((ma4−β)/α, (mb4−Γ)/α) as the pseudo-operation information about C4 and the off-signal indicating termination of the touch operation to the smart phone 1. At step S18, the process performs the above-mentioned smart phone display area outside process, and then returns to step S1 to repeat the flow.

According to the flowchart in FIG. 9, the display coordinate conversion is described as the zoom operation and the parallel shift operation but is not limited thereto. For example, the display may be rotated similarly. To rotate the display, the process detects two touch operations. The process may rotate the display when detecting a slide operation for only one of the touch operations. In this case, the initial point for the slide operation is rotated around the fixed touch operation position (hereinafter referred to as a fixed point) as much as a predetermined setup quantity (e.g., angle) until a given position is reached. Coordinates for that position may be defined as the ending point coordinates for simplified input. Pseudo-slide data may be generated from the initial point to the ending point coordinates for simplified input. In this case, the pseudo-slide data may contain coordinates for virtual operation positions on an arc that is formed around the fixed point between the initial point and the ending point coordinates for simplified input.

The smart phone 1 receives the pseudo-operation information that is transmitted in accordance with the flowchart in FIG. 9. Based on the pseudo-operation information, the mobile-side control portion 15 of the smart phone 1 determines at which position of the screen displayed on the mobile touch panel portion 14 the operation was performed. The mobile-side control portion 15 performs a process corresponding to the position where the operation was performed. In detail, when receiving the pseudo-operation information transmitted with the on-signal, the mobile-side control portion 15 performs a process corresponding to the touch operation at coordinates indicated by the pseudo-operation information. When receiving the pseudo-operation information transmitted with the off-signal, the mobile-side control portion 15 performs a process corresponding to the touch-off state at coordinates indicated by the pseudo-operation information.

Based on the pseudo-operation information, the smart phone 1 can perform the display coordinate conversion such as the zooming and the parallel shift in the same manner as operations on the mobile touch panel portion 14. According to the embodiment, the smart phone 1 receives the pseudo-operation information about the pseudo-slide data as well as the initial point and the ending point coordinates for simplified input. The smart phone 1 can perform operations on the assumption that a touch operation occurs at positions corresponding to the initial point and the ending point coordinates for simplified input. In addition, the smart phone 1 can perform operations on the assumption that a touch operation occurs at positions from the initial point to the ending point coordinates for simplified input. The smart phone 1 can perform the zooming and the parallel shift with smooth display as if a slide operation took place on the mobile touch panel portion 14.

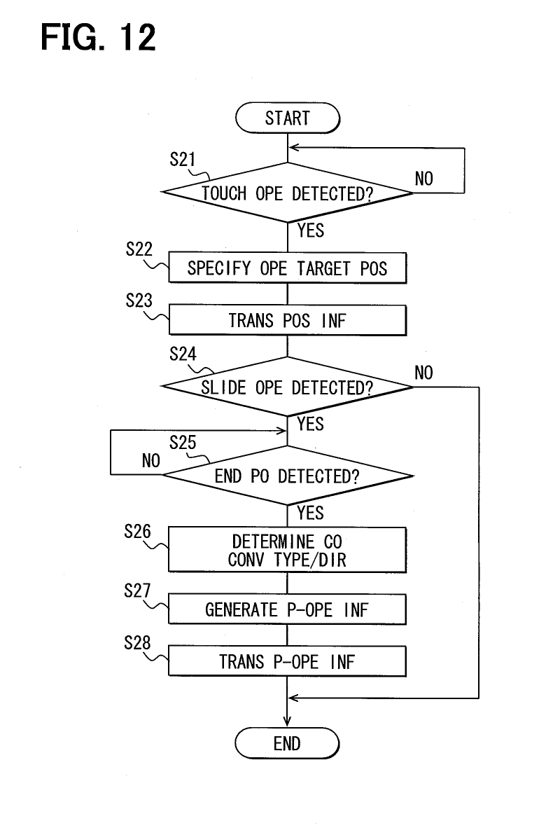

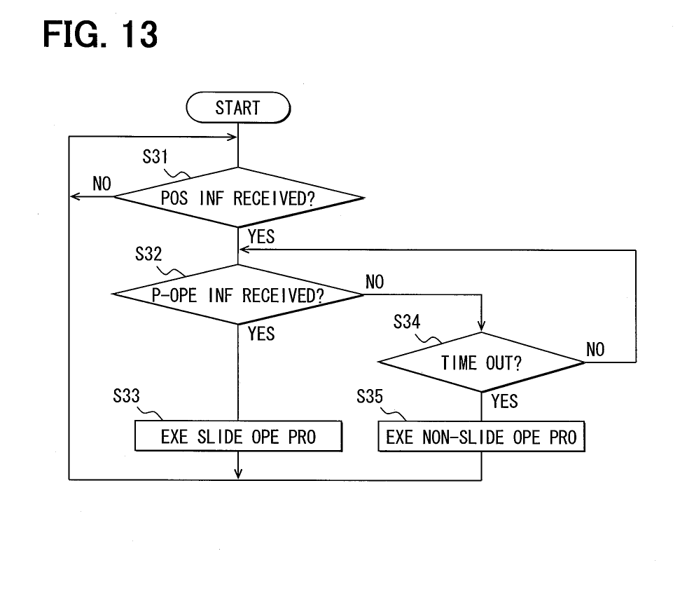

There have been described the example processes of converting coordinates for the image display on the screens of the vehicular display apparatus 2 and the smart phone 1 when the terminal mode is used. The following processes are also available. With reference to FIGS. 12 and 13, the following describes other example processes of converting coordinates for the image display on the screens of the vehicular display apparatus 2 and the smart phone 1 when the terminal mode is used. With reference to FIG. 12, the following describes an example process flow in the vehicular display apparatus 2 when the terminal mode is used. FIG. 12 is a flowchart showing a process in the vehicle-side control portion 25 when terminal mode is used. The flow in FIG. 12 is assumed to start when the vehicle-side communication portion 21 receives mobile-originated screen data from the smart phone 1 and the vehicle-side display portion 22 displays the screen corresponding to the mobile-originated screen data.

At step S21, the process detects a touch operation for the screen displayed on the vehicular touch panel portion 24 and detects the number of operation positions for the touch operation. The process proceeds to step S22 if the touch operation is detected (YES at step S21). The process returns to step S21 and repeats the flow if no touch operation is detected (NO at step S21).

At step S22, the process specifies the operation target position corresponding to the coordinates of the operation position for the detected touch operation and proceeds to step S23. The operation target position is equivalent to coordinates that belong to the screen of the mobile touch panel portion 14 of the smart phone 1 and correspond to the coordinates of the operation position for the touch operation.

At step S23, the process allows the vehicle-side communication portion 21 to transmit the information (the above-mentioned position information) about the coordinates specified as the operation target position at step S22 to the smart phone 1. The process then proceeds to step S24. At step S23, the process transmits the position information corresponding to one or two operation positions for the touch operation depending on the number of detected operation positions.

At step S24, the process detects a slide operation following the touch operation detected at step S21. If the slide operation is detected (YES at step S24), the process proceeds to step S25. Two operation positions may be detected for the touch operation. In such a case, the process proceeds to step S25 if a slide operation is detected for at least one of the two operation positions. The process terminates the flow if no slide operation is detected (NO at step S24).

At step S25, the process detects the slide operation ending point. The process proceeds to step S26 if the slide operation ending point is detected (YES at step S25). The process repeats step S25 if the slide operation ending point is not detected (NO at step S25). The slide operation may be detected at two operation positions. In such a case, the process repeats step S25 until the ending point of each slide operation is detected.

At step S26, the process settles the coordinate conversion type and direction based on the number of operation positions and the coordinates of the starting and ending points for the slide operation and then proceeds to step S27. For example, the vehicle-side control portion 25 determines the coordinate conversion type and direction as follows.

The vehicle-side control portion 25 may detect only one operation position. In this case, the vehicle-side control portion 25 determines the coordinate conversion type as parallel shift and determines the parallel shift direction from the slide operation starting point to the slide operation ending point.

The vehicle-side control portion 25 may detect two operation positions and detect a slide operation for both positions. In this case, the vehicle-side control portion 25 determines the coordinate conversion type as scale conversion. Let us suppose a ratio of the distance between the slide operation ending points to the distance between the slide operation starting points. The vehicle-side control portion 25 determines the scale conversion direction as enlargement if the ratio is greater than 1. The vehicle-side control portion 25 determines the scale conversion direction as reduction if the ratio is smaller than 1.

The vehicle-side control portion 25 may detect two operation positions and may detect a slide operation for only one of them. In this case, the vehicle-side control portion 25 determines the coordinate conversion type as rotation. Let us suppose an angle before change formed by a line drawn between a fixed operation position and the slide operation starting point. Let us suppose an angle after change formed by a line drawn between the fixed operation position and the slide operation ending point. The vehicle-side control portion 25 determines the rotation direction in accordance with a difference between the angle after change and the angle before change. For example, let us suppose that an angle is formed based on the abscissa axis passing through the fixed operation position. The vehicle-side control portion 25 determines the rotation direction to be clockwise if the angle after change is smaller than the angle before change. The vehicle-side control portion 25 determines the rotation direction to be counterclockwise if the angle after change is larger than the angle before change.

At step S27, the process generates the pseudo-operation information corresponding to the type and the direction determined in the vehicle-side control portion 25, and then proceeds to step S28. At step S28, the process allows the vehicle-side communication portion 21 to transmit the pseudo-operation information generated at step S27 to the smart phone 1, and then terminates the flow.

As described above, the slide operation may be detected for two operation positions. In this case, the process transmits the pseudo-operation information corresponding to coordinates of the ending points for both slide operations. The slide operation may be detected for only one of the two operation positions. In this case, the process transmits not only the pseudo-operation information but also information about the coordinates that belong to the screen of the mobile touch panel portion 14 of the smart phone 1 and correspond to the coordinates of the fixed operation position.

In the flow in FIG. 12, similarly to the flow in FIG. 9, the process may specify the initial point, the coordinates for the slide operation ending point (that is, the ending point coordinates for simplified input), and the operation target position for pseudo-slide data. The process may transmit the specified operation target position as the pseudo-operation information to the smart phone 1.

With reference to FIG. 13, the following describes a process flow concerning the coordinate conversion of the image display on the screen of the smart phone 1 in response to information transmitted from the vehicular display apparatus 2 when the terminal mode is used. FIG. 13 is a flowchart showing a process in the mobile-side control portion 15 when the terminal mode is used. The flow in FIG. 13 is assumed to start when the mobile-side control portion 15 generates display data or display area information to be displayed on the mobile touch panel portion 14 and transmits the generated data or information to the vehicular display apparatus 2. The flow is assumed to terminate when the terminal mode turns off.

At step S31, the process determines whether position information is received from the vehicular display apparatus 2. For this purpose, it may be preferable to determine whether position information is supplied from the mobile-side communication portion 11. The process proceeds to step S32 if the position information is received according to the determination (YES at step S31). The process repeats step S31 if no position information is received according to the determination (NO at step S31).

At step S32, the process determines whether pseudo-operation information is received from the vehicular display apparatus 2. For this purpose, it may be preferable to determine whether pseudo-operation information is supplied from the mobile-side communication portion 11. The process proceeds to step S33 if the pseudo-operation information is received according to the determination (YES at step S32). The process proceeds to step S34 if no pseudo-operation information is received according to the determination (NO at step S32).

At step S33, the process performs a slide operation process and then returns to step S31 to repeat the flow. The slide operation process applies the coordinate conversion such as parallel shift, scale conversion, or rotation to an image displayed on the screen of the mobile touch panel portion 14 in accordance with the position information and the pseudo-operation information received from the vehicular display apparatus 2.

The slide operation process will be described in detail. The slide operation process uses starting point coordinates indicated by the position information received from the vehicular display apparatus 2. The slide operation process uses ending point coordinates indicated by the pseudo-operation information received from the vehicular display apparatus 2. The slide operation process detects the number of operation positions from the number of coordinates indicated by the position information. The slide operation process detects a slide operation from the coordinates indicated by the position information and the coordinates indicated by the pseudo-operation information. The slide operation process detects the number of operation positions and the slide operation in the same manner as used when a touch operation is performed on the mobile touch panel portion 14.

Similarly to the above-mentioned coordinate conversion process, the slide operation process performs constant-quantity coordinate conversion based on the number of operation positions and the slide operation that are detected. The constant-quantity coordinate conversion includes parallel shift, scale conversion, or rotation of the image display on the screen of the mobile touch panel portion 14. The constant-quantity coordinate conversion uses coordinates for the slide operation starting point, that is, coordinates for the position corresponding to the actual operation position on the screen of the vehicular touch panel portion 24. The constant-quantity coordinate conversion uses coordinates for the slide operation ending point, that is, coordinates changed from the coordinates for the position corresponding to the actual operation position on the screen of the vehicular touch panel portion 24. Further in other words, the conversion uses coordinates for a position distant from the starting point after the constant-quantity coordinate conversion is performed. The coordinates for the operation starting point are not changed. The coordinates for the operation ending point are changed. The slide operation process applies the coordinate conversion to the image display and then allows the mobile-side communication portion 11 to transmit screen data for displaying the screen after the coordinate conversion to the vehicular display apparatus 2.

At step S34, the process determines whether a specified time has expired (time-out) as elapsed time from the determination at step S31 that the position information has been received. For example, the specified time may represent several seconds or any specifiable values. A timer circuit (not shown) may keep track of the elapsed time. The process proceeds to step S35 if the time-out condition occurs according to the determination (YES at step S34). The process returns to step S32 and repeats the flow if no time-out condition occurs according to the determination (NO at step S34).

At step S35, the process performs a non-slide operation process and then returns to step S31 to repeat the flow. The non-slide operation process follows the position information received from the vehicular display apparatus 2 and determines at which screen position displayed on the mobile touch panel portion 14 an operation was performed. The non-slide operation process performs a process related to the position where the operation was performed. If a button indication occurs, for example, the non-slide operation process performs a process related to the button indication. If that process needs to display a new screen, the non-slide operation process allows the mobile-side communication portion 11 to transmit screen data for displaying the new screen to the vehicular display apparatus 2.

The above-mentioned embodiment describes the configuration about the coordinate conversion of image display on the screen. The same configuration may be applied to coordinate conversion of object display on the screen.

According to the above-mentioned configuration, the smart phone 1 can apply the coordinate conversion as much as the constant quantity to the screen displayed on the mobile touch panel portion 14 in accordance with a slide operation on the vehicular touch panel portion 24 each time the smart phone 1 receives the pseudo-operation information. In this case, the coordinate conversion follows the type and the direction determined in the vehicle-side control portion 25.

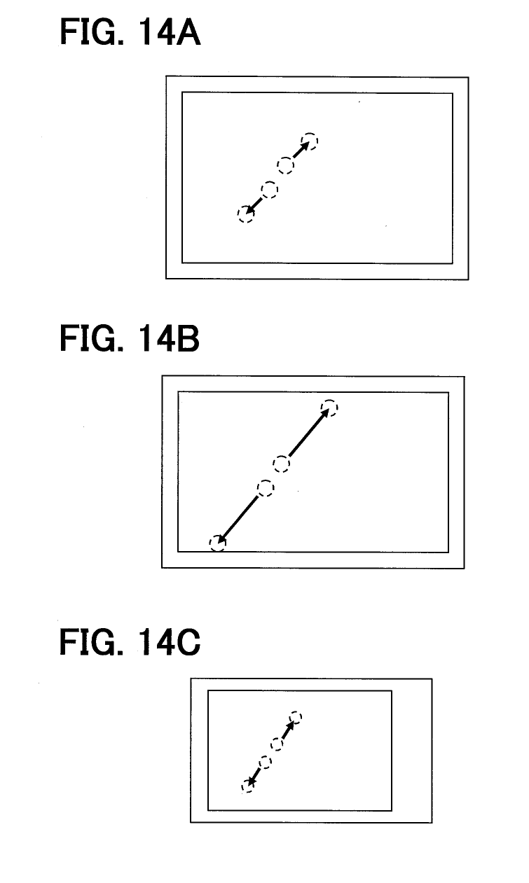

With reference to FIGS. 14A through 14C, the following describes a slide operation (hereinafter referred to as a pinch-out operation) in the direction to move two operation positions away from each other so that the display on the screen is enlarged. FIG. 14A is a schematic diagram showing operation position changes when a relatively small operation quantity of pinch-out operation is performed on the vehicular touch panel portion 24. FIG. 14B is a schematic diagram showing operation position changes when a relatively large operation quantity of pinch-out operation is performed on the vehicular touch panel portion 24. FIG. 14C is a schematic diagram showing operation position changes in a slide operation detected on the smart phone 1 based on position information and pseudo-operation information transmitted from the vehicular display apparatus 2. Broken-line circles in FIGS. 14A and 14B illustrate operation positions detected in the vehicular display apparatus 2. Broken-line circles in FIG. 14C illustrate operation positions detected in the smart phone 1. FIGS. 14A and 14B assume the same operation positions as the starting points.

According to the configuration of the embodiment, the vehicular display apparatus 2 transmits the same pseudo-operation information regardless of whether the pinch-out operation is performed on the vehicular touch panel portion 24 based on a relatively small operation quantity (see FIG. 14A) or a relatively large operation quantity (see FIG. 14B). The smart phone 1 detects a constant change in operation positions for slide operations regardless of operation quantities for the pinch-out operations (see FIG. 14C). Accordingly, an image magnification percentage is fixed regardless of pinch-out operation quantities. The configuration according to the embodiment enables the constant-quantity coordinate conversion regardless of slide operation quantities.

In the terminal mode, the vehicular display apparatus 2 displays the screen of the smart phone 1 on the vehicular touch panel portion 24. Each of slide operations on the vehicular touch panel 24 enables a constant quantity of coordinate conversion with the type and the direction dependent on the slide operation regardless of operation quantities for the slide operation.

The coordinate conversion quantity is constant regardless of slide operation quantities. A user can perform a targeted quantity of coordinate conversion just by adjusting the number of slide operations without adjusting the operation quantity for each slide operation. The user needs to watch the screen of the vehicular touch panel portion 24 in order to adjust the slide operation quantity. On the other hand, the user need not watch the screen when adjusting the number of slide operations. The above-mentioned configuration can improve the usability for users to use functions of the smart phone 1 on the vehicular display apparatus 2 while the smart phone 1 is connected to the vehicular display apparatus 2.

The configuration according to the embodiment uses multi-touch panels for the mobile touch panel portion 14 and the vehicular touch panel portion 24 but is not limited thereto. For example, the vehicular touch panel portion 24 may use a touch panel (hereinafter referred to as a single-touch panel) that cannot simultaneously detect multiple operation positions on the screen. The following describes the next embodiment (modification 1) with reference to the accompanying drawings. For convenience of the description, the same reference numerals or symbols are given to members having the same functions as those of the members shown in the drawings used to explain the above-mentioned embodiment and a detailed description is omitted.

If the vehicular touch panel portion 24 uses a single-touch panel, the vehicular touch panel portion 24 displays an icon that specifies the direction, zoom, or rotation for the parallel shift. The vehicular touch panel portion 24 transmits pseudo-operation information corresponding to the touch operation on the icon in order to perform the coordinate conversion such as parallel shift, scale conversion, or rotation on images.

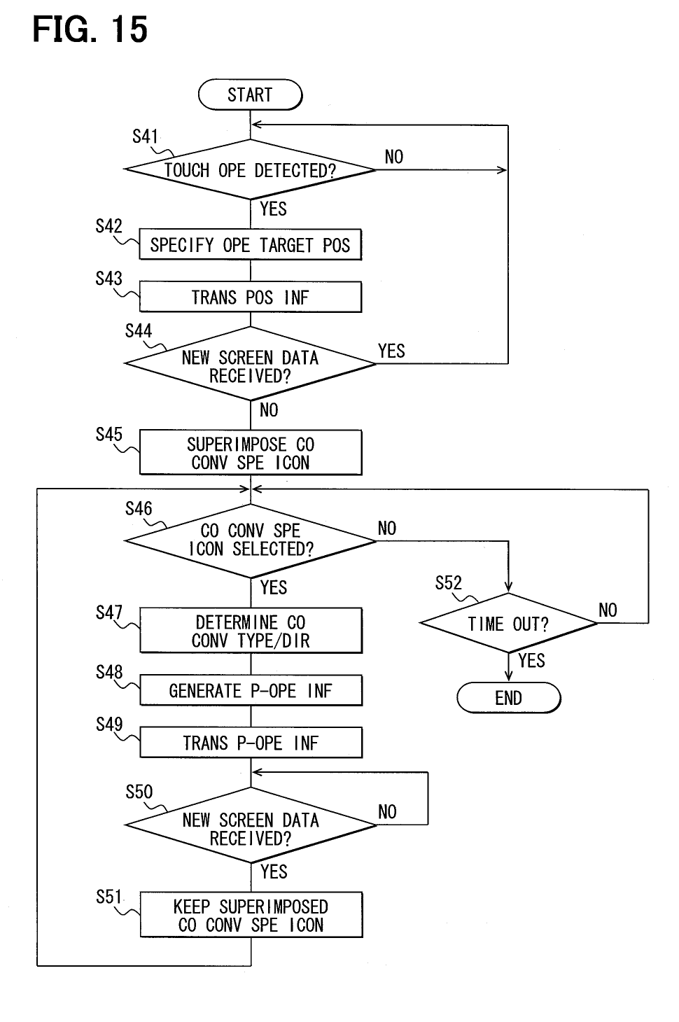

With reference to FIG. 15, the following describes a process flow in the vehicular display apparatus 2 according to modification 1 when the terminal mode is used. FIG. 15 is a flowchart showing a process in the vehicle-side control portion 25 according to modification 1 when the terminal mode is used. The flow in FIG. 15 is assumed to start when the vehicle-side communication portion 21 accepts mobile-originated screen data transmitted from the smart phone 1 and the vehicle-side display portion 22 displays a screen indicated by the mobile-originated screen data.

At step S41, the process detects a touch operation on the screen displayed in the vehicular touch panel portion 24. The process proceeds to step S42 if the touch operation is detected (YES at step S41). The process returns to step S41 and repeats the flow if no touch operation is detected (NO at step S41).

At step S42, the process specifies the operation target position corresponding to the coordinates of the operation position for the touch operation detected at step S41 and proceeds to step S43. The operation target position indicates coordinates that belong to the screen of the mobile touch panel portion 14 of the smart phone 1 and correspond to the coordinates of the operation position for the touch operation. At step S43, the process allows the vehicle-side communication portion 21 to transmit the information (that is, the above-mentioned position information) about coordinates specified at step S42 as the operation target position to the smart phone 1 and proceeds to step S44.

At step S44, the process determines whether new screen data is received from the smart phone 1. For this purpose, it may be preferable to determine whether new screen data is supplied from the vehicle-side communication portion 21. The process returns to step S41 and repeats the flow if the new screen data is received according to the determination (YES at step S44). In this case, it is assumed that a touch operation is performed on the button indication on the screen and the screen transitions accordingly. The process proceeds to step S45 if no new screen data is received according to the determination (NO at step S44). In this case, it is assumed that a touch operation is performed on an object or an image other than the button indication on the screen.

At step S45, the process superimposes an icon (hereinafter referred to as a coordinate conversion specification icon) on the screen of the vehicular touch panel portion 24 and proceeds to step S46. The coordinate conversion specification icon is displayed around coordinates of the operation position for the touch operation detected at step S41 and allows a user to specify the type and the direction of coordinate conversion for the image display on the screen. The vehicle-side control portion 25 is equivalent to a first superimpose display means. The touch operation detected at step S41 is equivalent to a first touch operation. The first touch operation precedes a touch operation on the coordinate conversion specification icon to be described later. The first touch operation is performed on an object or an image other than the button indication on the screen while the coordinate conversion specification icon is not superimposed.

The coordinate conversion specification icon is displayed each time the parallel shift direction, the zooming, or the rotation direction is specified, for example. It is desirable to transparently display the coordinate conversion specification icon so as to reveal the display below the superimposed coordinate conversion specification icon.

There is predetermined correspondence relation between the placement position of each coordinate conversion specification icon and the coordinate conversion type and direction indicated by each coordinate conversion specification icon with reference to the center of each coordinate conversion specification icon. The correspondence relation (hereinafter referred to as correspondence relation for placement position determination) is stored in nonvolatile memory such as EEPROM of the vehicle-side control portion 25, for example. The vehicle-side control portion 25 is equivalent to a predetermination storage means.

Based on the correspondence relation for placement position determination, the vehicle-side control portion 25 determines the placement position of each coordinate conversion specification icon around the coordinates of the operation position for the detected touch operation and displays each coordinate conversion specification icon. Based on the correspondence relation for placement position determination, the vehicle-side control portion 25 finds correspondence relation between the determined placement position of each coordinate conversion specification icon and the coordinate conversion type and direction indicated by each coordinate conversion specification icon. The vehicle-side control portion 25 stores the correspondence relation (hereinafter referred to as correspondence relation for selected icon specification) in temporary memory such as RAM. The vehicle-side control portion 25 is equivalent to a storage means.

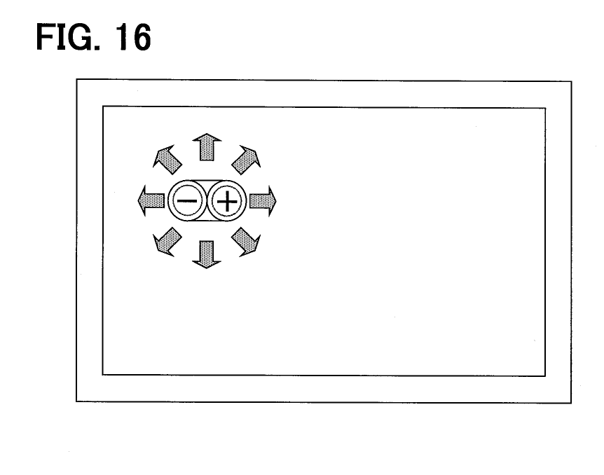

The embodiment will be described with reference to two types of coordinate conversion specification icons superimposed on each other as shown in FIG. 16. One specifies eight parallel shift directions such as top, top right, right, bottom right, bottom, bottom left, left, and top left. The other specifies enlargement and reduction. In FIG. 16, each arrow represents the coordinate conversion specification icon that specifies the parallel shift direction. The “+” symbol represents the coordinate conversion specification icon for enlargement. The “−” symbol represents the coordinate conversion specification icon for reduction.

At step S46 in FIG. 15, the process determines whether a touch operation (selection) is performed on the coordinate conversion specification icon. For this purpose, it may be preferable to determine whether the operation position for a re-touch operation after the touch operation detected at step S41 is equivalent to the placement position of the coordinate conversion specification icon. The touch operation detected at step S41 need not necessarily terminate. The coordinate conversion specification icon is associated with the above-mentioned correspondence relation for selected icon specification. The process proceeds to step S47 if the coordinate conversion specification icon is selected according to the determination (YES at step S46). The process proceeds to step S52 if the coordinate conversion specification icon is not selected according to the determination (NO at step S46). The touch operation position may be also assumed to be equivalent to the placement position of the coordinate conversion specification icon if the touch operation position approximates to the placement position of the coordinate conversion specification icon within a specified range. In this case, the coordinate conversion specification icon can be easily selected without increasing the display size of the coordinate conversion specification icon, that is, without hiding the information display behind the coordinate conversion specification icon.

At step S47, the process settles the coordinate conversion type and direction and then proceeds to step S48. For this purpose, the process references the correspondence relation for selected icon specification based on the touch operation position. In detail, the process determines the coordinate conversion type and direction associated with the placement position equivalent to the touch operation position.

For example, selecting the coordinate conversion specification icon for specifying the right direction determines the coordinate conversion type as parallel shift and the direction as right. Selecting the coordinate conversion specification icon for specifying the enlargement determines the coordinate conversion type as scale conversion and the direction as enlargement. Selecting the coordinate conversion specification icon for specifying the reduction determines the coordinate conversion type as scale conversion and the direction as reduction.

At step S48, the process generates information about coordinates for the starting point and the ending point of the slide operation on the mobile touch panel portion 14, and then proceeds to step S49. In this case, it is assumed that a slide operation is performed on the mobile touch panel portion 14 in order to perform the coordinate conversion on the screen display as much as the constant quantity. The type and the direction of the coordinate conversion is determined at step S47. Modification 1 assumes information about coordinates for the starting point and the ending point to be pseudo-operation information. The constant quantity also denotes any specifiable fixed value. The constant quantity may include different fixed values corresponding to the coordinate conversion types.

For example, the process may determine the coordinate conversion as parallel shift and the coordinate conversion direction as right. In this case, the process generates pseudo-operation information using a starting point at coordinates that belong to the screen of the mobile touch panel portion 14 of the smart phone 1 and correspond to the operation position coordinates for the touch operation detected at step S41. The process also generates pseudo-operation information using a starting point at coordinates moved from the coordinates of that starting point to the right for the constant quantity. The process also generates pseudo-operation information similarly if the coordinate conversion direction is not right. The process generates one type of information about the starting point coordinates and one type of information about the ending point coordinates if the coordinate conversion type is parallel shift.

The process may determine the coordinate conversion type as scale conversion and the coordinate conversion direction as enlargement. In this case, the center is assumed to be coordinates (hereinafter referred to as reference coordinates) that belong to the screen of the mobile touch panel portion 14 of the smart phone 1 and correspond to the coordinates of the operation position for the touch operation detected at step S41. Based on the center, the process positions two points with a first distance between them and generates pseudo-operation information using these points as the starting point coordinates. The first distance is shorter than a second distance described below and can be set to any value. Based on the reference coordinates as the center, the process positions two points with a second distance between them and generates pseudo-operation information using these points as the ending point coordinates. The second distance is longer than the first distance and can be set to any value. A fixed value is used as a ratio between the first distance and the second distance.

The process may determine the coordinate conversion type as scale conversion and the coordinate conversion direction as reduction. Based on the reference coordinates as the center, the process positions two points with the second distance between them and generates pseudo-operation information using these points as the starting point coordinates. Based on the reference coordinates as the center, the process positions two points with the first distance between them and generates pseudo-operation information using these points as the ending point coordinates. The process generates two types of information about the starting point coordinates and two types of information about the ending point coordinates if the coordinate conversion type is scale conversion.

Though not described in detail, the process according to the embodiment may determine the coordinate conversion type as rotation. In this case, the process settles one starting point corresponding to the reference coordinates and another starting point corresponding to coordinates at a specified distance from the reference coordinates to the right, for example. The process generates pseudo-operation information using these starting points. The process settles one ending point corresponding to the reference coordinates and another ending point corresponding to coordinates at a specified distance from the reference coordinates to the top right (counterclockwise direction) or to the bottom right (clockwise direction), for example. The process generates pseudo-operation information using these ending points.

At step S49, the process allows the vehicle-side communication portion 21 to transmit the pseudo-operation information generated at step S48 to the smart phone 1 and then proceeds to S50. When transmitting the pseudo-operation information at step S49, the process first transmits the information about the starting point coordinates and, after a specified time interval, transmits the information about the ending point coordinates. Any value is specifiable as the specified time interval. For example, the time interval may be set to one second or shorter.

Similarly to the above-mentioned embodiment, modification 1 may also specify the starting point coordinates (initial point), the ending point coordinates (ending point coordinates for simplified input), and the operation target position for the pseudo-slide data. The specified operation target position may be transmitted as the pseudo-operation information to the smart phone 1. In this case, the process transmits the pseudo-operation information about the starting point coordinates, the pseudo-operation information about the pseudo-slide data, and then the pseudo-operation information about the ending point coordinates in this order at a specified time interval. Any value is specifiable as the specified time interval. For example, the time interval may be predetermined in consideration of natural display or response rate and the throughput of the smart phone 1.

At step S50, the process determines whether new screen data is received from the smart phone 1. For this purpose, the process may determine whether the vehicle-side communication portion 21 supplies new screen data. If new screen data is received according to the determination (YES at step S50), the process allows the vehicular touch panel portion 24 to display a screen corresponding to the new screen data and then proceeds to step S51. If new screen data is not received according to the determination (NO at step S50), the process repeats step S50.

At step S51, the process superimposes the coordinate conversion specification icon at the same position as the superimpose display at step S45 also on the new screen displayed on the vehicular touch panel portion 24. The process keeps the coordinate conversion specification icon superimposed. The process then returns to step S46 and repeats the flow.

At step S52, the process determines whether a specified time has expired (time-out) as elapsed time from the time the coordinate conversion specification icon is displayed on the screen of the vehicular touch panel portion 24. The elapsed time is measured after the coordinate conversion specification icon is superimposed again at step S51 if this is the case. For example, the specified time may represent several seconds or any specifiable values. A timer circuit (not shown) may keep track of the elapsed time. The process terminates the flow if the time-out condition occurs according to the determination (YES at step S52). The process returns to step S46 and repeats the flow if no time-out condition occurs according to the determination (NO at step S52).

When receiving the pseudo-operation information, the smart phone 1 detects the number of operation positions from the number of starting point coordinates indicated by the pseudo-operation information. The smart phone 1 detects a slide operation based on the starting point coordinates and the ending point coordinates indicated by the pseudo-operation information. The smart phone 1 detects the number of operation positions and the slide operation in the same manner as the touch operation performed on the mobile touch panel portion 14. Similarly to the above-mentioned coordinate conversion process, the smart phone 1 performs the coordinate conversion in accordance with the number of operation positions and the slide operation detected. Again, the coordinate conversion includes parallel shift, scale conversion, or rotation of images displayed on the screen of the mobile touch panel portion 14.

According to the above-mentioned configuration, the smart phone 1 can apply the coordinate conversion for the constant quantity to a display on the screen of the mobile touch panel portion 14 each time the smart phone 1 receives the pseudo-operation information. The coordinate conversion is performed in response to a touch operation at the display position of the coordinate conversion specification icon superimposed on the screen of the vehicular touch panel portion 24. The type and the direction of the coordinate conversion are determined in the vehicle-side control portion 25.

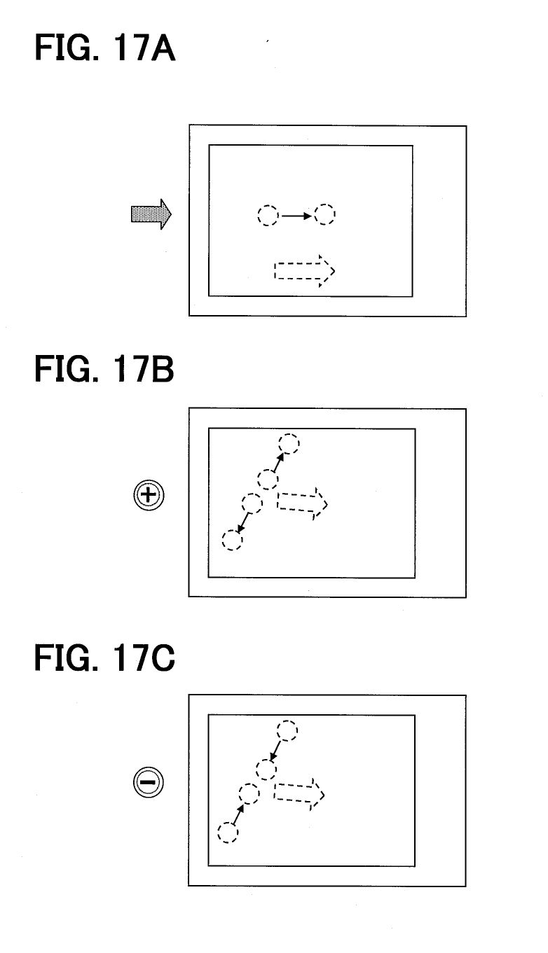

With reference to FIGS. 17A through 17C, the following describes the coordinate conversion of an image that is displayed on the screen of the mobile touch panel portion 14 in response to a touch operation at the display position of the coordinate conversion specification icon. FIG. 16 is a schematic diagram showing the coordinate conversion specification icon. FIGS. 17A through 17C are schematic diagrams showing operation position changes in slide operations detected on the smart phone 1 when the coordinate conversion specification icon is touched.

FIG. 17A exemplifies a touch operation on the coordinate conversion specification icon that specifies the parallel shift to the right. FIG. 17B exemplifies a touch operation on the coordinate conversion specification icon that specifies the enlargement. FIG. 17C exemplifies a touch operation on the coordinate conversion specification icon that specifies the reduction. Broken-line circles in FIGS. 17A through 17C illustrate operation positions detected in the smart phone 1. Broken-line arrows in FIGS. 17A through 17C illustrate the shift direction of an image on the screen.

The description below assumes the following. The scale conversion such as enlargement or reduction is applied to an image on the screen in the same manner as the conversion of coordinates of the center between ending points for the detected slide operations into coordinates of the screen center. The scale conversion also includes a process of parallel shifting the center between the slide operation ending points to the screen center.

According to the configuration of the modification 1, the smart phone 1 detects the slide operation for the constant quantity to the right of the screen if a touch operation is performed on the coordinate conversion specification icon that specifies the parallel shift to the right (see FIG. 17A). As a result, the smart phone 1 shifts to the right the position of the image displayed on the screen of the mobile touch panel portion 14.

The smart phone 1 detects a slide operation for the constant quantity in the direction to move two operation positions away from each other if a touch operation is performed on the coordinate conversion specification icon that specifies the enlargement (see FIG. 17B). As a result, the smart phone 1 enlarges an image displayed on the screen of the mobile touch panel portion 14 and shifts the image so that the center between the slide operation ending points coincides with the screen center.

The smart phone 1 detects a slide operation for the constant quantity in the direction to move two operation positions closer to each other if a touch operation is performed on the coordinate conversion specification icon that specifies the reduction (see FIG. 17C). As a result, the smart phone 1 reduces an image displayed on the screen of the mobile touch panel portion 14 and shifts the image so that the center between the slide operation ending points coincides with the screen center. Therefore, a single touch operation on the coordinate conversion specification icon supplies a constant value to the parallel shift quantity or the image zooming percentage.

The configuration of modification 1 allows a single touch operation on the coordinate conversion specification icon to perform the constant-quantity coordinate conversion. A user can perform a targeted quantity of coordinate conversion just by adjusting the number of touch operations on the coordinate conversion specification icon. The user need not watch the screen of the vehicular touch panel portion 24 when adjusting the number of touch operations on the coordinate conversion specification icon. The above-mentioned configuration can also improve the usability for users to use functions of the smart phone 1 on the vehicular display apparatus 2 while the smart phone 1 is connected to the vehicular display apparatus 2.

According to the above-mentioned configuration, the vehicular touch panel portion 24 can allow a single touch operation on the display position of the coordinate conversion specification icon to enable the coordinate conversion that is available on the smart phone 1 by simultaneously sliding the two positions on the screen. Therefore, the vehicular touch panel portion 24 can use a single-touch panel to enable the coordinate conversion that is available on the smart phone 1 by simultaneously operating the two positions on the screen. The versatility is improved.

Moreover, the above-mentioned configuration can keep the coordinate conversion specification icon superimposed at the same position on the screen within a specified time interval after the coordinate conversion specification icon is selected. This facilitates touch operations when a user repeats a touch operation on the coordinate conversion specification icon to perform a targeted quantity of coordinate conversion. The usability for users further improves.

Modification 1 has provided the configuration of superimposing the coordinate conversion specification icon around a position of detecting the touch operation on the screen of the vehicular touch panel portion 24, but is not limited thereto. For example, the coordinate conversion specification icon may be located at a specified position on the screen of the vehicular touch panel portion 24 regardless of touch operation positions. In this case, the configuration may eliminate the above-mentioned correspondence relation for placement position determination.

The vehicular touch panel portion 24 may display a specified frame if the vehicular touch panel portion 24 uses a single-touch panel. Pseudo-operation information may be generated in accordance with the positional relation between the frame and a touch operation position. The pseudo-operation information may be transmitted to the smart phone 1 so as to apply the coordinate conversion such as parallel shift or scale conversion to images. The following describes the embodiment (modification 2) with reference to the accompanying drawings. For convenience of the description, the same reference numerals or symbols are given to members having the same functions as those of the members shown in the drawings used to explain the above-mentioned embodiment and a detailed description is omitted.

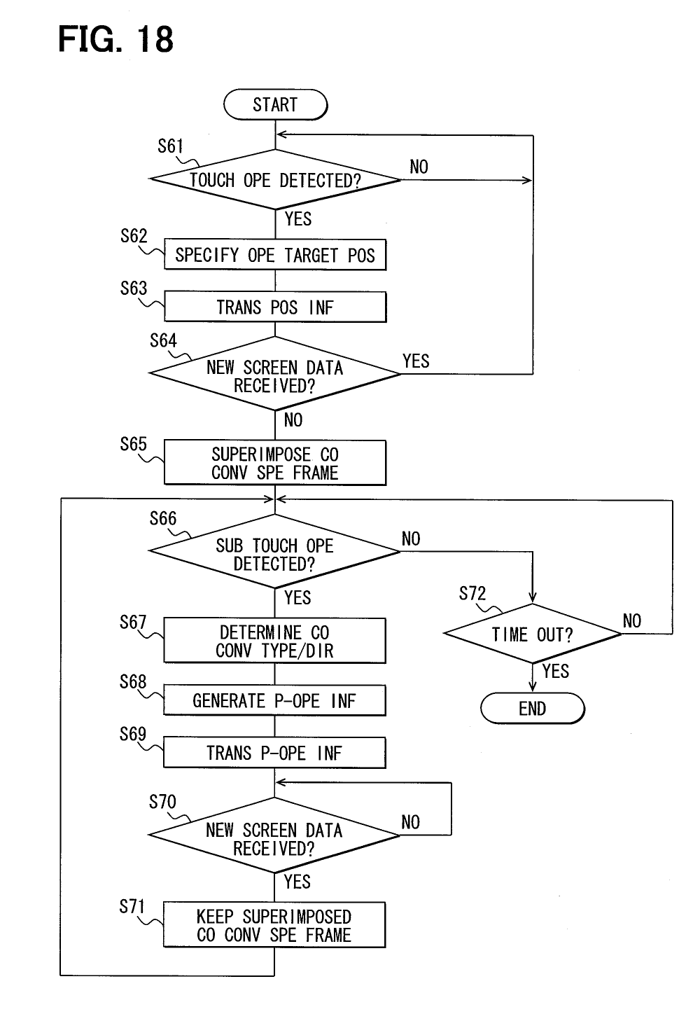

With reference to FIG. 18, the following describes a process flow in the vehicular display apparatus 2 according to modification 2 when the terminal mode is used. FIG. 18 is a flowchart showing a process in the vehicle-side control portion 25 according to modification 2 when the terminal mode is used. The flow in FIG. 18 is assumed to start when the vehicle-side communication portion 21 accepts mobile-originated screen data transmitted from the smart phone 1 and the vehicle-side display portion 22 displays a screen indicated by the mobile-originated screen data.

At step S61, the process determines whether a touch operation is detected on the vehicular touch panel portion 24. The process proceeds to step S62 if a touch operation is detected according to the determination (YES at step S61). The process returns to step S61 and repeats the flow if no touch operation is detected (NO at step S61).

At step S62, the process specifies the operation target position corresponding to the coordinates of the operation position for the detected touch operation and proceeds to step S63. The operation target position indicates coordinates that belong to the screen of the mobile touch panel portion 14 of the smart phone 1 and correspond to the coordinates of the operation position for the touch operation. At step S63, the process allows the vehicle-side communication portion 21 to transmit the information (that is, the above-mentioned position information) about coordinates specified at step S62 as the operation target position to the smart phone 1 and proceeds to step S64.

At step S64, the process determines whether new screen data is received from the smart phone 1. The process returns to step S61 and repeats the flow if the new screen data is received according to the determination (YES at step S64). In this case, it is assumed that a touch operation is performed on the button indication on the screen and the screen transitions accordingly. The process proceeds to step S65 if no new screen data is received according to the determination (NO at step S64). In this case, it is assumed that a touch operation is performed on an object or an image other than the button indication on the screen.

At step S65, the process superimposes a specified frame on the screen of the vehicular touch panel portion 24 around coordinates for the operation position of the detected touch operation. The process then proceeds to step S66. Accordingly, vehicle-side control portion 25 is equivalent to a second superimpose display means. The specified frame is hereinafter referred to as a coordinate conversion specification frame.

The coordinate conversion specification frame is designed at a predetermined placement position (position of rendering lines configuring the frame) corresponding to its center. For example, nonvolatile memory such as EEPROM in the vehicle-side control portion 25 stores information (frame placement position information) about the placement position of the coordinate conversion specification frame based on its center. Based on the frame placement position information, the vehicle-side control portion 25 determines the placement position of the coordinate conversion specification frame centered at the coordinates of the operation position for the detected touch operation. The vehicle-side control portion 25 then displays the coordinate conversion specification frame.

In the description below, a rectangular frame illustrated by broken lines shown in FIG. 19 is superimposed as the coordinate conversion specification frame according to the embodiment. The broken-line circle in FIG. 19 illustrates the operation position for a touch operation. In the description below, the embodiment assumes the coordinate conversion specification frame to be rectangular while it may be circular or shaped otherwise.

At step S66 in FIG. 18, the process determines whether the touch operation (preceding touch operation) detected at step S61 is followed by another touch operation (subsequent touch operation). The process proceeds to step S67 if the subsequent touch operation is performed according to determination (YES at step S66). The process proceeds to step S72 if no subsequent touch operation is performed according to the determination (YES at step S66).

The preceding touch operation is equivalent to a first touch operation. The first touch operation precedes the subsequent touch operation and is performed on an object or an image other than the button indication on the screen while the coordinate conversion specification frame is not superimposed.

At step S67, the process determines the coordinate conversion type and direction and then proceeds to step S68. For this purpose, the process determines positional relation between the coordinate conversion specification frame and the placement position at the operation position for the subsequent touch operation based on the operation position and the frame placement position information about the subsequent touch operation. In detail, the process may determine that the operation position for the subsequent touch operation is located on the coordinate conversion specification frame. In this case, the process settles the coordinate conversion type as the parallel shift. In addition, the process settles a direction from the operation position for the preceding touch operation to the operation position for the subsequent touch operation as the parallel shift direction. The process may determine that the operation position for the subsequent touch operation is located inside the coordinate conversion specification frame. In this case, the process settles the coordinate conversion type as the scale conversion and the scale direction as reduction. The process may determine that the operation position for the subsequent touch operation is located outside the coordinate conversion specification frame. In this case, the process settles the coordinate conversion type as the scale conversion and the scale direction as enlargement. The touch operation position may be located within a specified range of the coordinate conversion specification frame. In this case, the process may also determine that the touch operation position is located on the coordinate conversion specification frame. This enables to facilitate the touch operation (positioning) on the coordinate conversion specification frame without enlarging (thickening) the size of the coordinate conversion specification frame or without degrading visibility of the information display behind the frame line.

At step S68, the process generates information about coordinates for the starting point and the ending point of the slide operation on the mobile touch panel portion 14, and then proceeds to step S69. In this case, it is assumed that a slide operation is performed on the mobile touch panel portion 14 in order to perform the coordinate conversion on the screen display as much as the constant quantity. The type and the direction of the coordinate conversion is determined at step S67. Modification 2 also assumes information about coordinates for the starting point and the ending point to be pseudo-operation information. The constant quantity also denotes any specifiable fixed value. The constant quantity may include different fixed values corresponding to the coordinate conversion types.

For example, the process may determine the coordinate conversion as parallel shift and the coordinate conversion direction as only right except the vertical shift. In this case, the process generates pseudo-operation information using a starting point at coordinates that belong to the screen of the mobile touch panel portion 14 of the smart phone 1 and correspond to the operation position coordinates for the touch operation detected at step S61.

The process also generates pseudo-operation information using a starting point at coordinates moved from the coordinates of that starting point to the right only except the vertical shift for the constant quantity. The process similarly generates the pseudo-operation information even if the coordinate conversion type is parallel shift and the coordinate conversion direction is specified otherwise. The process generates one type of information about the starting point coordinates and one type of information about the ending point coordinates if the coordinate conversion type is parallel shift.

The process may determine the coordinate conversion type as scale conversion and the coordinate conversion direction as enlargement. In this case, the center is assumed to be coordinates (hereinafter referred to as reference coordinates) that belong to the screen of the mobile touch panel portion 14 of the smart phone 1 and correspond to the coordinates of the operation position for the preceding touch operation. Based on the center, the process positions two points with a first distance between them and generates pseudo-operation information using these points as the starting point coordinates. The first distance is shorter than a second distance described below and can be set to any value. Based on the reference coordinates as the center, the process positions two points with a second distance between them and generates pseudo-operation information using these points as the ending point coordinates. The second distance is longer than the first distance and can be set to any value. A fixed value is used as a ratio between the first distance and the second distance.

The process may determine the coordinate conversion type as scale conversion and the coordinate conversion direction as reduction. Based on the reference coordinates as the center, the process positions two points with the second distance between them and generates pseudo-operation information using these points as the starting point coordinates. Based on the reference coordinates as the center, the process positions two points with the first distance between them and generates pseudo-operation information using these points as the ending point coordinates. The process generates two types of information about the starting point coordinates and two types of information about the ending point coordinates if the coordinate conversion type is scale conversion.

At step S69, the process allows the vehicle-side communication portion 21 to transmit the pseudo-operation information generated at step S58 to the smart phone 1 and then proceeds to S70. When transmitting the pseudo-operation information at step S69, the process first transmits the information about the starting point coordinates and, after a specified time interval, transmits the information about the ending point coordinates. Any value is specifiable as the specified time interval. For example, the time interval may be set to one second or shorter.

Similarly to the above-mentioned embodiment, modification 2 may also specify the starting point coordinates (initial point), the ending point coordinates (ending point coordinates for simplified input), and the operation target position for the pseudo-slide data. The specified operation target position may be transmitted as the pseudo-operation information to the smart phone 1. In this case, the process transmits the pseudo-operation information about the starting point coordinates, the pseudo-operation information about the pseudo-slide data, and then the pseudo-operation information about the ending point coordinates in this order at a specified time interval. Any value is specifiable as the specified time interval. For example, the time interval may be predetermined in consideration of natural display or response rate and the throughput of the smart phone 1.

At step S70, the process determines whether new screen data is received from the smart phone 1. If new screen data is received according to the determination (YES at step S70), the process displays a screen corresponding to the new screen data on the screen of the vehicular touch panel portion 24 and proceeds to step S71. If no new screen data is received according to the determination (NO at step S70), the process repeats the flow at step S70.

At step S71, the process keeps the coordinate conversion specification frame superimposed. That is, the process superimposes the coordinate conversion specification frame at the same position as for the superimposition at step S65 also on the screen newly displayed on the vehicular touch panel portion 24. The process then returns to step S66 and repeats the flow.

At step S72, the process determines whether a specified time has expired (time-out) as elapsed time from the time the coordinate conversion specification frame is displayed on the screen of the vehicular touch panel portion 24. The elapsed time is measured after the coordinate conversion specification frame is superimposed again at step S71 if this is the case. For example, the specified time may represent several seconds or any specifiable values. A timer circuit (not shown) may keep track of the elapsed time. The process terminates the flow if the time-out condition occurs according to the determination (YES at step S72). The process returns to step S66 and repeats the flow if no time-out condition occurs according to the determination (NO at step S72).

When receiving the pseudo-operation information, the smart phone 1 detects the number of operation positions from the number of starting point coordinates indicated by the pseudo-operation information. The smart phone 1 detects a slide operation based on the starting point coordinates and the ending point coordinates indicated by the pseudo-operation information. The smart phone 1 detects the number of operation positions and the slide operation in the same manner as the touch operation performed on the mobile touch panel portion 14. Similarly to the above-mentioned coordinate conversion process, the smart phone 1 performs the coordinate conversion in accordance with the number of operation positions and the slide operation detected. Again, the coordinate conversion includes parallel shift, scale conversion, or rotation of images displayed on the screen of the mobile touch panel portion 14.

According to the above-mentioned configuration, the smart phone 1 can apply the coordinate conversion for the constant quantity to a display on the screen of the mobile touch panel portion 14 each time the smart phone 1 receives the pseudo-operation information. The coordinate conversion is performed in accordance with the positional relation between the placement position of the coordinate conversion specification frame and the operation position for the subsequent touch operation. The coordinate conversion specification frame is superimposed on the screen of the vehicular touch panel portion 24. The type and the direction of the coordinate conversion are determined in the vehicle-side control portion 25.

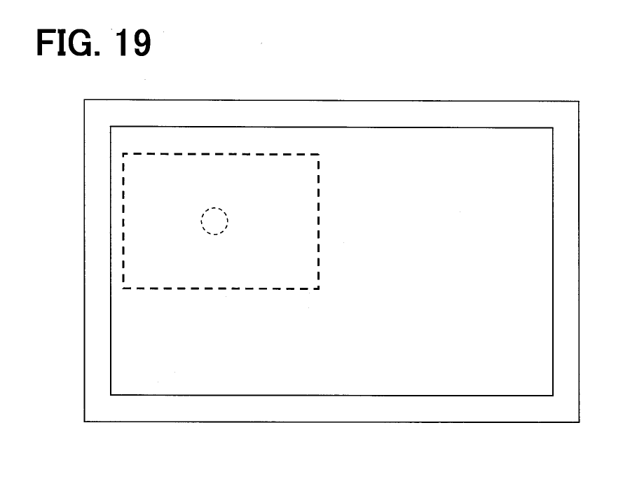

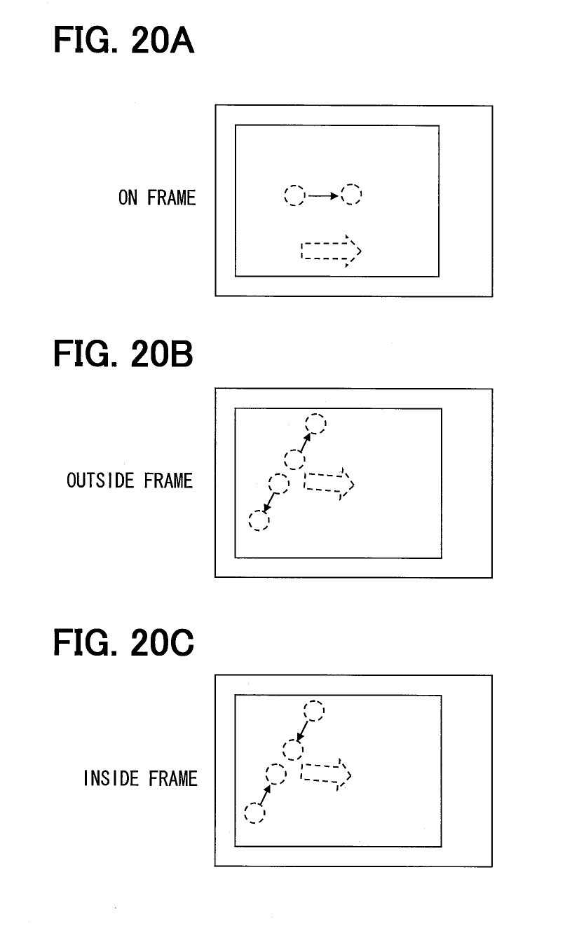

With reference to FIG. 19 and FIGS. 20A through 20C, the following describes the coordinate conversion of images displayed on the screen of the mobile touch panel portion 14 in accordance with the positional relation between the placement position of the coordinate conversion specification frame and the operation position for the subsequent touch operation. FIG. 19 is a schematic diagram showing the coordinate conversion specification frame. FIGS. 20A through 20C are schematic diagrams showing operation position changes in slide operations detected on the smart phone 1 in accordance with positional relation between placement positions of the coordinate conversion specification frame and operation positions of a subsequent touch operation.

FIG. 20A exemplifies a subsequent touch operation performed on the coordinate conversion specification frame. FIG. 20B exemplifies a subsequent touch operation performed outside the coordinate conversion specification frame. FIG. 20C exemplifies a subsequent touch operation performed inside the coordinate conversion specification frame. Broken-line circles in FIGS. 20A through 20C illustrate operation positions detected in the smart phone 1. Broken-line arrows in FIGS. 20A through 20C illustrate the shift direction of an image on the screen.

The description below assumes the following. The scale conversion such as enlargement or reduction is applied to an image on the screen in the same manner as the conversion of coordinates of the center between ending points for the detected slide operations into coordinates of the screen center. The scale conversion also includes a process of parallel shifting the center between the slide operation ending points to the screen center.

According to the configuration of modification 2, the subsequent touch operation may be performed on the coordinate conversion specification frame vertically the same position to the right of the operation position for the preceding touch operation. In this case, the smart phone 1 detects a slide operation for the constant quantity only in the right direction without vertical shift on the screen (see FIG. 20A). As a result, the smart phone 1 moves the image position displayed on the screen of mobile touch panel portion 14 only to the right without vertical shift.

The subsequent touch operation may be performed outside the coordinate conversion specification frame. In this case, the smart phone 1 detects a slide operation for the constant quantity in the direction to move two operation positions away from each other (see FIG. 20B). As a result, the smart phone 1 enlarges an image displayed on the screen of the mobile touch panel portion 14 and shifts the image so that the center between the slide operation ending points coincides with the screen center.

A touch operation may be performed inside the coordinate conversion specification frame. In this case, the smart phone 1 detects a slide operation for the constant quantity in the direction to move two operation positions closer to each other (see FIG. 20C). As a result, the smart phone 1 reduces an image displayed on the screen of the mobile touch panel portion 14 and shifts the image so that the center between the slide operation ending points coincides with the screen center. Therefore, a single subsequent touch operation supplies a constant value to the parallel shift quantity or the image zooming percentage.

The configuration according to modification 2 performs the constant-quantity coordinate conversion per subsequent touch operation. A user can perform a targeted quantity of coordinate conversion just by adjusting the number of subsequent touch operations. The user need not watch the screen of the vehicular touch panel portion 24 when adjusting the number of subsequent touch operations. The above-mentioned configuration can also improve the usability for users to use functions of the smart phone 1 on the vehicular display apparatus 2 while the smart phone 1 is connected to the vehicular display apparatus 2.

According to the above-mentioned configuration, the vehicular touch panel portion 24 can allow a single touch operation on the screen after superimposition of the coordinate conversion specification frame to enable the coordinate conversion that is available on the smart phone 1 by simultaneously sliding the two positions on the screen. Therefore, the vehicular touch panel portion 24 can use a single-touch panel to enable the coordinate conversion that is available on the smart phone 1 by simultaneously operating the two positions on the screen. The versatility is improved.

Moreover, the above-mentioned configuration can keep the coordinate conversion specification frame superimposed at the same position on the screen within a specified time interval after a touch operation subsequent to superimposition of the coordinate conversion specification frame. This facilitates touch operations when a user repeats a touch operation on the coordinate conversion specification frame to perform a targeted quantity of coordinate conversion. The usability for users further improves.

The above disclosure has the following aspects.

According to a first aspect of the present disclosure, a display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus includes: a vehicular touch panel mounted on the vehicle and displaying a vehicle-side image corresponding to received screen data of the mobile terminal. The display apparatus specifies a mobile position of the mobile touch panel, which corresponds to a touch position of the vehicular touch panel when a user touches the vehicular touch panel to operate the display apparatus. The display apparatus transmits information indicative of a specified mobile position of the mobile touch panel. The display apparatus further includes: a detector that detects a slide operation of the touch position of the vehicular touch panel when the user slides the touch position of the vehicular touch panel, and that detects a slid touch position of the vehicular touch panel; a conversion mode determination device that determines a type of display coordinate conversion based on the slide operation detected by the detector, and that determines a direction of the display coordinate conversion based on the touch position and the slid touch position detected by the detector; and a pseudo-operation information generation device that generates pseudo-operation information indicating the mobile position and a slid mobile position, which corresponds to the slid touch position of the vehicular touch panel, assuming that an operation for providing the type and the direction of the display coordinate conversion determined by the conversion mode determination device is performed on the mobile touch panel by a predetermined constant quantity. The display apparatus transmits the pseudo-operation information to the mobile terminal.

In the above apparatus, each time a slide operation is performed once, the conversion mode determination device settles the type and the direction of display coordinate conversion. The pseudo-operation information generation device generates the pseudo-operation information and transmits it to the mobile terminal. As mentioned above, the pseudo-operation information indicates a change of an operation position on the touch panel of the mobile terminal on the assumption that an operation is performed on the touch panel in order to perform coordinate conversion with a type and a direction determined by the conversion mode determination device on a screen display as much as a constant quantity. Therefore, the mobile terminal can apply the coordinate conversion as much as a constant quantity to a screen display on the touch panel of the mobile terminal each the mobile terminal receives the pseudo-operation information.

The vehicular display apparatus displays a mobile terminal screen on the vehicular touch panel. Each time a slide operation is performed once, the vehicular display apparatus applies constant-quantity coordinate conversion with the type and the direction settled for the slide operation to a screen display on the vehicular touch panel. The coordinate conversion quantity is constant regardless of slide operation quantities. A user can perform a targeted quantity of coordinate conversion just by adjusting the number of slide operations without adjusting the operation quantity for each slide operation. The user needs to watch the vehicular touch panel portion in order to adjust the slide operation quantity. On the other hand, the user need not watch the vehicular touch panel when adjusting the number of slide operations. The above apparatus can improve the usability for users to use functions of the mobile terminal on the vehicular display apparatus while the mobile terminal is connected to the vehicular display apparatus.

Alternatively, the vehicular touch panel may simultaneously detect a plurality of touch positions thereof. Further, the conversion mode determination device may determine the type of the display coordinate conversion as parallel shift when the vehicular touch panel detects only one touch position and the detector detects the slide operation of the touch position. The conversion mode determination device determines the direction of the display coordinate conversion as a parallel shift direction based on the touch position and the slid touch position. In this case, the user can repeat a slide operation on the vehicular touch panel and thereby parallel shift a screen display on the vehicular touch panel in the slide operation direction as much as a targeted quantity.

Alternatively, the conversion mode determination device may determine the type of the display coordinate conversion as scale conversion when the vehicular touch panel simultaneously detects two touch positions and the detector detects the slide operations of two touch positions, respectively so that the detector detects a change of a distance between two touch positions. The conversion mode determination device determines the direction of the display coordinate conversion as one of an enlargement direction and a reduction direction in accordance with the change of the distance. In this case, the user can repeat a slide operation at two operation positions on the vehicular touch panel and thereby enlarge or reduce a screen display on the vehicular touch panel as much as a targeted quantity.

Alternatively, the conversion mode determination device may determine the type of the display coordinate conversion as rotation when the vehicular touch panel simultaneously detects two touch positions and the detector detects only the slide operation of one touch position. The conversion mode determination device determines the direction of the rotation based on the touch positions and the slid touch position. In this case, the user can repeat a slide operation at only one of the two operation positions on the vehicular touch panel and thereby rotate a screen display on the vehicular touch panel as much as a targeted quantity.

Alternatively, the pseudo-operation information may include coordinates of the mobile position as a virtual operation starting point, coordinates of the slid mobile position as a virtual operation ending point, and coordinates of one or more virtual operation intermediate points between the virtual operation starting point and the virtual operation ending point. The display apparatus successively transmits the pseudo-operation information in an order from coordinates of the virtual operation starting point, coordinates of the virtual operation intermediate point approximate to the virtual operation starting point, coordinates of the virtual operation intermediate point approximate to the virtual operation ending point, to coordinates of the virtual operation ending point. In this case, the mobile terminal successively receives coordinates from the operation intermediate point approximate to the operation starting point up to the operation ending point in order. The coordinate conversion is applied to a screen display on the touch panel of the mobile terminal each time the mobile terminal receives the coordinates. Finally, the constant-quantity coordinate conversion is performed. Therefore, the mobile terminal smoothes screen changes based on the pseudo-operation information.

According to a second aspect of the present disclosure, a display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus includes: a vehicular touch panel mounted on the vehicle and displaying a vehicle-side image corresponding to received screen data of the mobile terminal. The display apparatus specifies a first mobile position of the mobile touch panel, which corresponds to a first touch position of the vehicular touch panel when a user firstly touches the vehicular touch panel to operate the display apparatus. The display apparatus transmits information indicative of a specified first mobile position of the mobile touch panel. The display apparatus further includes: a detector that detects a re-touch operation of the vehicular touch panel when the user secondly touches the vehicular touch panel to operate the display apparatus after the user firstly touches the vehicular touch panel, and that detects a second touch position of the vehicular touch panel, which is different from the first touch position; a first superimpose display device that controls the vehicular touch panel to superimpose an icon over the vehicle-side image when the user firstly touches the vehicular touch panel, the icon being used for the user to specify a type and a direction of display coordinate conversion; a conversion mode determination device that determines based on the second touch position detected by the detector whether the user selects the icon, and that determines the type and the direction of display coordinate conversion so as to correspond to the icon selected by the user when the conversion mode determination device determines that the user selects the icon; and a pseudo-operation information generation device that generates pseudo-operation information indicating the first mobile position and a converted first mobile position, which is prepared assuming that an operation for providing the type and the direction of the display coordinate conversion determined by the conversion mode determination device is performed on the mobile touch panel by a predetermined constant quantity. The display apparatus transmits the pseudo-operation information to the mobile terminal.

In the above apparatus, a touch operation allows the screen of the vehicular touch panel to superimpose an icon for the user to specify a type and a direction of the display coordinate conversion. The user can then touch the display position of the icon to apply the coordinate conversion with the user-specified type and direction to the screen display as much as the constant quantity. The vehicular touch panel can allow a single touch operation at the display position of the icon to enable the coordinate conversion that is available on the mobile terminal by simultaneously operating two positions on the screen. Accordingly, the vehicular touch panel enables the coordinate conversion that is available by simultaneously operating two locations on a mobile terminal screen even though the vehicular touch panel cannot simultaneously detect multiple operation positions. The versatility is improved.

Alternatively, the first superimpose display device may control the vehicular touch panel to superimpose the icon over the vehicle-side image around the first touch position as a center when the user firstly touches the vehicular touch panel. The display apparatus further includes: a storage device that stores information about a relationship between a display position of the icon on the vehicular touch panel and the type and the direction of display coordinate conversion, which correspond to the icon; and a predetermination storage device that preliminary defines and stores information about a relationship between a placement position of the icon with respect to the center and the type and the direction of display coordinate conversion, which corresponds to the icon. The storage device stores the information about the relationship between the display position of the icon and the type and the direction of display coordinate conversion according to the information preliminary defined and stored in the predetermination storage device. The conversion mode determination device references the information stored in the storage device so that the conversion mode determination device determines the type and the direction of display coordinate conversion. In this case, the icon is displayed around the operation position for the touch operation so that a user can specify the type and the direction of the display coordinate conversion. The icon can be easily selected thereafter. The usability for users further improves.

Alternatively, the icon may include at least one of an icon for the user to specify a parallel shift direction of the vehicle-side image, an icon for the user to specify a zooming operation of the vehicle-side image, and an icon for the user to specify a rotation direction of the vehicle-side image. In this case, a touch operation at the icon display position can enable parallel shift, enlargement, reduction, and rotation of the display.

According to a third aspect of the present disclosure, a display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus includes: a vehicular touch panel mounted on the vehicle and displaying a vehicle-side image corresponding to received screen data of the mobile terminal. The display apparatus specifies a first mobile position of the mobile touch panel, which corresponds to a first touch position of the vehicular touch panel when a user firstly touches the vehicular touch panel to operate the display apparatus. The display apparatus transmits information indicative of a specified first mobile position of the mobile touch panel. The display apparatus further includes: a detector that detects a re-touch operation of the vehicular touch panel when the user secondly touches the vehicular touch panel to operate the display apparatus after the user firstly touches the vehicular touch panel, and that detects a second touch position of the vehicular touch panel, which is different from the first touch position; a second superimpose display device that controls the vehicular touch panel to superimpose a predetermined frame over the vehicle-side image when the user firstly touches the vehicular touch panel, the predetermined frame enclosing the first touch position of the vehicular touch panel; a conversion mode determination device that determines a positional relationship between the frame and the second touch position based on the second touch position detected by the detector and a placement position of the frame, and that determines a type and a direction of display coordinate conversion in accordance with determined positional relationship; and a pseudo-operation information generation device that generates pseudo-operation information indicating the first mobile position and a converted first mobile position, which is prepared assuming that an operation for providing the type and the direction of the display coordinate conversion determined by the conversion mode determination device is performed on the mobile touch panel by a predetermined constant quantity. The display apparatus transmits the pseudo-operation information to the mobile terminal.

In the above apparatus, a touch operation allows the screen of the vehicular touch panel to superimpose the specified frame around the operation position for the touch operation. After the frame is displayed, the user can touch the screen to apply the coordinate conversion with the user-specified type and direction to the screen display as much as the constant quantity. The vehicular touch panel can allow a single touch operation on the screen with the frame displayed to enable the coordinate conversion that is available on the mobile terminal by simultaneously operating two positions on the screen. Accordingly, the vehicular touch panel enables the coordinate conversion that is available by simultaneously operating two locations on a mobile terminal screen even though the vehicular touch panel cannot simultaneously detect multiple operation positions. The versatility is improved.

Alternatively, when the conversion mode determination device determines that the second touch position is disposed on the frame, the conversion mode determination device may determine the type of the display coordinate conversion as a parallel shift, and determines the direction of the display coordinate conversion as a parallel shift direction, which is a direction from the first touch position to the second touch position. When the conversion mode determination device determines that the second touch position is disposed inside the frame, the conversion mode determination device determines the type of the display coordinate conversion as scale conversion, and determines the direction of the display coordinate conversion as a reduction direction. When the conversion mode determination device determines that the second touch position is disposed outside the frame, the conversion mode determination device determines the type of the display coordinate conversion as the scale conversion, and determines the direction of the display coordinate conversion as an enlargement direction.

Alternatively, the display apparatus may further include: a setup device that sets the predetermined constant quantity in the pseudo-operation information according to a user operation. In this case, the constant quantity can be changed to a user-specified value.

According to a fourth aspect of the present disclosure, an information display system includes: a mobile terminal having a touch panel; and the display apparatus according to one of first to third aspects. The mobile terminal receives the pseudo-operation information transmitted from the display apparatus. The mobile terminal controls the mobile touch panel to perform the operation for providing the type and the direction of the display coordinate conversion to the mobile image by the predetermined constant quantity according to the pseudo-operation information.

The above system enables to improve the usability for users to use functions of the mobile terminal on the vehicular display apparatus while the mobile terminal is connected to the vehicular display apparatus.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus comprising:
a vehicular touch panel mounted on the vehicle and displaying a vehicle-side image corresponding to received screen data of the mobile terminal,
wherein the display apparatus specifies a mobile position of the mobile touch panel, which corresponds to a touch position of the vehicular touch panel when a user touches the vehicular touch panel to operate the display apparatus,
wherein the display apparatus transmits information indicative of a specified mobile position of the mobile touch panel,
the display apparatus further comprising:
a detector that detects a slide operation of the touch position of the vehicular touch panel when the user slides the touch position of the vehicular touch panel, and that detects a slid touch position of the vehicular touch panel;
a conversion mode determination device that determines a type of display coordinate conversion based on the slide operation detected by the detector, and that determines a direction of the display coordinate conversion based on the touch position and the slid touch position detected by the detector; and
a pseudo-operation information generation device that generates pseudo-operation information indicating the mobile position and a slid mobile position, which corresponds to the slid touch position of the vehicular touch panel, assuming that an operation for providing the type and the direction of the display coordinate conversion determined by the conversion mode determination device is performed on the mobile touch panel by a predetermined constant quantity,
wherein the display apparatus transmits the pseudo-operation information to the mobile terminal.

2. The display apparatus according to claim 1,
wherein the vehicular touch panel simultaneously detects a plurality of touch positions thereof.

3. The display apparatus according to claim 2,
wherein the conversion mode determination device determines the type of the display coordinate conversion as parallel shift when the vehicular touch panel detects only one touch position and the detector detects the slide operation of the touch position,
wherein the conversion mode determination device determines the direction of the display coordinate conversion as a parallel shift direction based on the touch position and the slid touch position.

4. The display apparatus according to claim 2,
wherein the conversion mode determination device determines the type of the display coordinate conversion as scale conversion when the vehicular touch panel simultaneously detects two touch positions and the detector detects the slide operations of two touch positions, respectively so that the detector detects a change of a distance between two touch positions,
wherein the conversion mode determination device determines the direction of the display coordinate conversion as one of an enlargement direction and a reduction direction in accordance with the change of the distance.

5. The display apparatus according to claim 2,
wherein the conversion mode determination device determines the type of the display coordinate conversion as rotation when the vehicular touch panel simultaneously detects two touch positions and the detector detects only the slide operation of one touch position, and
wherein the conversion mode determination device determines the direction of the rotation based on the touch positions and the slid touch position.

6. The display apparatus according to claim 1,
wherein the pseudo-operation information includes coordinates of the mobile position as a virtual operation starting point, coordinates of the slid mobile position as a virtual operation ending point, and coordinates of one or more virtual operation intermediate points between the virtual operation starting point and the virtual operation ending point, and
wherein the display apparatus successively transmits the pseudo-operation information in an order from coordinates of the virtual operation starting point, coordinates of the virtual operation intermediate point approximate to the virtual operation starting point, coordinates of the virtual operation intermediate point approximate to the virtual operation ending point, to coordinates of the virtual operation ending point.

7. A display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus comprising:
a vehicular touch panel mounted on the vehicle and displaying a vehicle-side image corresponding to received screen data of the mobile terminal,
wherein the display apparatus specifies a first mobile position of the mobile touch panel, which corresponds to a first touch position of the vehicular touch panel when a user firstly touches the vehicular touch panel to operate the display apparatus,
wherein the display apparatus transmits information indicative of a specified first mobile position of the mobile touch panel,
the display apparatus further comprising:
a detector that detects a re-touch operation of the vehicular touch panel when the user secondly touches the vehicular touch panel to operate the display apparatus after the user firstly touches the vehicular touch panel, and that detects a second touch position of the vehicular touch panel, which is different from the first touch position;
a first superimpose display device that controls the vehicular touch panel to superimpose an icon over the vehicle-side image when the user firstly touches the vehicular touch panel, the icon being used for the user to specify a type and a direction of display coordinate conversion;
a conversion mode determination device that determines based on the second touch position detected by the detector whether the user selects the icon, and that determines the type and the direction of display coordinate conversion so as to correspond to the icon selected by the user when the conversion mode determination device determines that the user selects the icon; and
a pseudo-operation information generation device that generates pseudo-operation information indicating the first mobile position and a converted first mobile position, which is prepared assuming that an operation for providing the type and the direction of the display coordinate conversion determined by the conversion mode determination device is performed on the mobile touch panel by a predetermined constant quantity,
wherein the display apparatus transmits the pseudo-operation information to the mobile terminal.

8. The display apparatus according to claim 7,
wherein the first superimpose display device controls the vehicular touch panel to superimpose the icon over the vehicle-side image around the first touch position as a center when the user firstly touches the vehicular touch panel,
the display apparatus further comprising:
a storage device that stores information about a relationship between a display position of the icon on the vehicular touch panel and the type and the direction of display coordinate conversion, which correspond to the icon; and
a predetermination storage device that preliminary defines and stores information about a relationship between a placement position of the icon with respect to the center and the type and the direction of display coordinate conversion, which corresponds to the icon,
wherein the storage device stores the information about the relationship between the display position of the icon and the type and the direction of display coordinate conversion according to the information preliminary defined and stored in the predetermination storage device, and
wherein the conversion mode determination device references the information stored in the storage device so that the conversion mode determination device determines the type and the direction of display coordinate conversion.

9. The display apparatus according to claim 7,
wherein the icon includes at least one of an icon for the user to specify a parallel shift direction of the vehicle-side image, an icon for the user to specify a zooming operation of the vehicle-side image, and an icon for the user to specify a rotation direction of the vehicle-side image.

10. A display apparatus for a vehicle, which is configured to communicate with a mobile terminal having a mobile touch panel, wherein the display apparatus receives screen data, which is generated in the mobile terminal so that the mobile terminal displays a mobile image of the screen data on the mobile touch panel, the apparatus comprising:
a vehicular touch panel mounted on the vehicle and displaying a vehicle-side image corresponding to received screen data of the mobile terminal,
wherein the display apparatus specifies a first mobile position of the mobile touch panel, which corresponds to a first touch position of the vehicular touch panel when a user firstly touches the vehicular touch panel to operate the display apparatus,
wherein the display apparatus transmits information indicative of a specified first mobile position of the mobile touch panel,
the display apparatus further comprising:
a detector that detects a re-touch operation of the vehicular touch panel when the user secondly touches the vehicular touch panel to operate the display apparatus after the user firstly touches the vehicular touch panel, and that detects a second touch position of the vehicular touch panel, which is different from the first touch position;
a second superimpose display device that controls the vehicular touch panel to superimpose a predetermined frame over the vehicle-side image when the user firstly touches the vehicular touch panel, the predetermined frame enclosing the first touch position of the vehicular touch panel;
a conversion mode determination device that determines a positional relationship between the frame and the second touch position based on the second touch position detected by the detector and a placement position of the frame, and that determines a type and a direction of display coordinate conversion in accordance with determined positional relationship; and
a pseudo-operation information generation device that generates pseudo-operation information indicating the first mobile position and a converted first mobile position, which is prepared assuming that an operation for providing the type and the direction of the display coordinate conversion determined by the conversion mode determination device is performed on the mobile touch panel by a predetermined constant quantity,
wherein the display apparatus transmits the pseudo-operation information to the mobile terminal.

11. The display apparatus according to claim 10,
wherein, when the conversion mode determination device determines that the second touch position is disposed on the frame, the conversion mode determination device determines the type of the display coordinate conversion as a parallel shift, and determines the direction of the display coordinate conversion as a parallel shift direction, which is a direction from the first touch position to the second touch position,
wherein, when the conversion mode determination device determines that the second touch position is disposed inside the frame, the conversion mode determination device determines the type of the display coordinate conversion as scale conversion, and determines the direction of the display coordinate conversion as a reduction direction, and
wherein, when the conversion mode determination device determines that the second touch position is disposed outside the frame, the conversion mode determination device determines the type of the display coordinate conversion as the scale conversion, and determines the direction of the display coordinate conversion as an enlargement direction.

12. The display apparatus according to claim 1, further comprising:
a setup device that sets the predetermined constant quantity in the pseudo-operation information according to a user operation.

13. An information display system comprising:
a mobile terminal having a touch panel; and
the display apparatus according to claim 1,
wherein the mobile terminal receives the pseudo-operation information transmitted from the display apparatus, and
wherein the mobile terminal controls the mobile touch panel to perform the operation for providing the type and the direction of the display coordinate conversion to the mobile image by the predetermined constant quantity according to the pseudo-operation information.
